(19) United States
(12) Patent Application Publication
(10) Pub. No.: US 2010/0081410 A1
(43) Pub. Date: Apr. 1, 2010

(54) RADIO FREQUENCY CIRCUIT, RADIO FREQUENCY POWER AMPLIFIER, AND SEMICONDUCTOR DEVICE

(76) Inventors: Junji KAIDO, Osaka (JP); Masahiko INAMORI, Osaka (JP); Kazuki TATEOKA, Kyoto (JP); Shingo MATSUDA, Kyoto (JP); Hirokazu MAKIHARA, Osaka (JP)

Correspondence Address: MCDERMOTT WILL & EMERY LLP, 600 13TH STREET, NW, WASHINGTON, DC, 20005-3096, US

(21) Appl. No.: 12/536,162

(22) Filed: Aug. 5, 2009

(30) Foreign Application Priority Data
Sep. 26, 2008 (JP) 2008-248668

(51) Int. Cl. H04B 1/16

(52) U.S. Cl. 455/341

(57) ABSTRACT

A radio frequency circuit according to the present invention, is a radio frequency circuit for amplifying a radio frequency signal, the radio frequency circuit comprising: an amplifier circuit for amplifying the radio frequency signal and outputting an amplified signal obtained by the amplification of the radio frequency signal; a load circuit connected to an output of the amplifier circuit; a plurality of transmission lines; a selection circuit for selecting a transmission line among the plurality of transmission lines in accordance with a predetermined parameter of the amplified signal so as to connect the selected transmission line to an output of the load circuit; and a conversion circuit for converting, into a predetermined load impedance, a load impedance looking from the amplifier circuit toward an output side of the amplifier circuit, the conversion being performed in the transmission line selected by the selection circuit.

### BACKGROUND OF THE INVENTION

1. Field of the Invention

The present invention relates to a radio frequency circuit, a radio frequency power amplifier, and a semiconductor device, and more particularly, to a radio frequency circuit, a radio frequency power amplifier, and a semiconductor device which are used for a mobile communication apparatus.

2. Description of the Background Art

A radio frequency power amplifier which is used for a mobile communication device and the like such as a mobile phone, includes a radio frequency circuit including: an amplifier circuit having an amplifying element, such as a transistor, which amplifies a radio frequency signal and outputs the amplified signal; and an output matching circuit for efficiently outputting the amplified signal.

In recent years, while a mobile phone is coming to have multiple functions, multiband operation of transmission signals, and multimode operation in which different modulation signals are used, become increasingly adopted for mobile phones. As a condition for realizing multiband operation or multimode operation, it is required to select a transmission line of a radio frequency signal from a plurality of transmission lines and to obtain an excellent output characteristic of each transmission line. In order to achieve this, there is suggested a selection circuit which enables a transmission line of a radio frequency signal to be selected in accordance with a frequency of the radio frequency signal, and enables an improved isolation (device isolation) characteristic to be obtained (for example, Japanese Laid-Open Patent Publication No. 9-321829 (hereinafter, referred to as Patent Document 1)). FIG. 18 is a diagram showing a configuration of a selection circuit disclosed in Patent Document 1.

In the conventional selection circuit shown in FIG. 18, when a radio frequency signal S1 (having a frequency f1) is used, a FET1 and a FET4 are turned ON, and a FET2 and a FET3 are turned OFF, so as to select a transmission line 1 which is provided between terminals 3 and 4. As a result, the radio frequency signal S1 passes through the transmission line 1 which is an ON path. Similarly, when a radio frequency signal S2 (having a frequency f2) is used, the FET1 and the FET4 are turned OFF, and the FET2 and the FET3 are turned OFF, so as to select a transmission line 2 which is provided between terminals 3 and 5. As a result, the radio frequency signal S2 passes through the transmission line 2 which is an ON path. By performing switching operation as described above, a transmission line is selected in accordance with a frequency of the radio frequency signal.

The conventional selection circuit shown in FIG. 18 includes a first bypass circuit which is a resonance circuit formed by the FET4, capacitors C1 and C3, and an inductance L4, and a second bypass circuit which is a resonance circuit formed by the FET3, the capacitor C1, a capacitor C2, and the inductance L4. When the transmission line 1 is selected and becomes an ON path, the first bypass circuit causes a slight amount of a signal, which is a portion of the radio frequency signal S1, flowing into the transmission line 2 which is an OFF path, to pass through the first bypass circuit to a ground terminal G. The capacitors C1 and C3 are set such that a resonance frequency of the first bypass circuit and the frequency f1 of the radio frequency signal S1 are equal to each other. When the transmission line 2 is selected and becomes an ON path, the second bypass circuit causes a slight amount of a signal, which is a portion of the radio frequency signal S2, flowing into the transmission line 1 which is an OFF path, to pass through the second bypass circuit to the ground terminal G The capacitors C1 and C2 are set such that a resonance frequency of the second bypass circuit and the frequency f2 of the radio frequency signal S2 are equal to each other. By using the first and the second bypass circuits as described above, the isolation (device isolation) characteristic improves.

However, each of the first and the second bypass circuits included in the above-described conventional selection circuit is a resonance circuit. Therefore, even if the above-described conventional selection circuit is adopted for the output matching circuit of the radio frequency circuit such that multiband operation or multimode operation can be performed in the radio frequency circuit (radio frequency power amplifier), it is impossible to appropriately control a load impedance looking from the amplifier circuit toward an output side of the amplifier circuit.

In addition, the first and the second bypass circuits included in the above-described conventional selection circuit are operated by using a resonance caused by an LC circuit. Therefore, in effect, the first bypass circuit causes not only a radio frequency signal of the frequency f1 but also some amount of a radio frequency signal of the frequency f2 to pass through the first bypass circuit to the ground terminal G. Similarly, the second bypass circuit causes not only a radio frequency signal of the frequency f2 but also some amount of a radio frequency signal of the frequency f1 to pass through the second bypass circuit to the ground terminal G. That is, in effect, when the transmission line 2 is an ON path, some amount of the radio frequency signal S2 which is to pass through the transmission line 2 is caused to pass through the first bypass circuit to the ground terminal G, whereas when the transmission line 1 is an ON path, some amount of the radio frequency signal S1 which is to pass through the transmission line 1 is caused to pass through the second bypass circuit to the ground terminal G. Thus, the above-described selection circuit has a problem that an insertion loss is increased. Accordingly, even if the above-described conventional selection circuit is introduced for the output matching circuit of the radio frequency circuit such that multiband operation or multimode operation can be performed in the radio frequency circuit (radio frequency power amplifier), an insertion loss is increased.

As described above, the above-described conventional selection circuit has a problem that it is impossible to appropriately control a load impedance and that an insertion loss is increased. Therefore, even if the above-described conventional selection circuit is adopted for the output matching circuit of the radio frequency circuit, it is impossible to cause each of the transmission lines to have an excellent output characteristic over a wide band, and it is difficult to realize a radio frequency circuit suitable for multiband operation or multimode operation.

### SUMMARY OF THE INVENTION

Therefore, an object of the present invention is to solve the problem that a load impedance cannot be controlled appropriately and that an insertion loss is increased, and to provide a radio frequency circuit, a radio frequency power amplifier, and a semiconductor device which are suitable for multiband operation and/or multimode operation.

In order to solve the above problem, the present invention has the following features. A radio frequency circuit according to the present invention is a radio frequency circuit for amplifying a radio frequency signal, the radio frequency circuit including: an amplifier circuit for amplifying the radio frequency signal and outputting an amplified signal obtained by the amplification of the radio frequency signal; a load circuit connected to an output of the amplifier circuit; a plurality of transmission lines; a selection circuit for selecting a transmission line among the plurality of transmission lines in accordance with a predetermined parameter of the amplified signal so as to connect the selected transmission line to an output of the load circuit; and a conversion circuit for converting, into a predetermined load impedance, a load impedance looking from the amplifier circuit toward an output side of the amplifier circuit, the conversion being performed in the transmission line selected by the selection circuit.

In some cases, it can occur that a load impedance looking from the amplifier circuit toward the output side of the amplifier circuit varies in accordance with a predetermined parameter of the amplified signal. Moreover, in some cases, it can occur that an optimum load impedance varies in accordance with the predetermined parameter of the amplified signal. Considering this, a load impedance looking from the amplifier circuit toward the output side of the amplifier circuit is converted in the transmission line selected by the selection circuit with use of the above-described configuration, thereby enabling the load impedance in accordance with the variations to be optimized. As a result, it becomes possible to cause each of the transmission lines to have an excellent output characteristic over a wide band, and also possible to realize a radio frequency circuit suitable for multiband operation or multimode operation.

The conversion circuit may include a plurality of impedance conversion circuits: which are provided and connected to the plurality of transmission lines, respectively; and each of which converts the load impedance into the predetermined load impedance in accordance with the predetermined parameter of the amplified signal passing through the corresponding one of the plurality of transmission lines.

Alternatively, the selection circuit may include a plurality of transistor circuits each of which: includes a plurality of switching transistors performing switching operation in accordance with the predetermined parameter of the amplified signal; and is provided between an output of the load circuit and each of the plurality of transmission lines; and the conversion circuit may include a plurality of impedance conversion circuits each of which: is provided to each of the plurality of transistor circuits and connected to a connection point existing among the plurality of switching transistors which are included in a corresponding transmission line; and converts the load impedance into the predetermined load impedance in accordance with the predetermined parameter of the amplified signal passing through the corresponding transistor circuit.

Alternatively, the conversion circuit may include a plurality of impedance conversion circuits: which are provided to the plurality of transmission lines, respectively; and each of which converts the load impedance into the predetermined load impedance in accordance with the predetermined parameter of the amplified signal passing through the corresponding one of the plurality of transmission lines, and the radio frequency circuit may further include a plurality of switching transistors which are provided to the plurality of impedance conversion circuits, respectively, and when the corresponding one of the transmission lines is selected by the selection circuit, connects the corresponding one of the impedance conversion circuits to the output of the load circuit by performing switching operation.

Alternatively, the plurality of transmission lines may be first and second transmission lines, the selection circuit may include: a first transistor circuit which is provided between the first transmission line and the output of the load circuit, and includes a plurality of first switching transistors which perform switching operation in accordance with the predetermined parameter of the amplified signal; and a second transistor circuit which is provided between the second transmission line and the output of the load circuit, and includes a plurality of second switching transistors which perform switching operation in accordance with the predetermined parameter of the amplified signal, the conversion circuit may include: a first impedance conversion circuit which is connected to a connection point existing among the plurality of first switching transistors, and converts the load impedance into the predetermined load impedance in accordance with the predetermined parameter of the amplified signal passing through the first transmission line; and a second impedance conversion circuit which is provided to the second transistor circuit, and converts the load impedance into the predetermined load impedance in accordance with the predetermined parameter of the amplified signal passing through the second transmission line, and the radio frequency circuit may further include a third switching transistor which is provided between the second switching transistor circuit and the second impedance conversion circuit, and when the first transmission line is selected by the selection circuit, connects the second switching transistor to the second impedance conversion circuit.

Alternatively, the plurality of transmission lines may be first and second transmission lines, the selection circuit may include: a first transistor circuit which is provided between the first transmission line and the output of the load circuit, and includes a plurality of first switching transistors which perform switching operation in accordance with the predetermined parameter of the amplified signal; and a second transistor circuit which is provided between the second transmission line and the output of the load circuit, and includes a plurality of second switching transistors which perform switching operation in accordance with the predetermined parameter of the amplified signal, and the conversion circuit may include: a passive circuit which is connected to a connection point existing among the plurality of second switching transistors and converts the load impedance into the predetermined load impedance in accordance with the predetermined parameter of the amplified signal passing through the second transmission line; and a third switching transistor which is connected to a connection point existing among the plurality of second switching transistors, and when the first transmission line is selected by the selection circuit, causes the passive circuit to be bypassed by performing switching operation.

The conversion circuit may include a capacitance or an inductance. The predetermined parameter may be a frequency of the amplified signal, an average power of the amplified signal, or a peak power of the amplified signal.

The radio frequency circuit may further include a bias circuit for supplying to the amplifier circuit a bias output having a bias current in accordance with the average power of the amplified signal or a bias voltage in accordance with the average power of the amplified signal.

The present invention is also directed to a semiconductor device. The semiconductor device according to the present invention includes the radio frequency circuit, at least one of the conversion circuit and the selection circuit being configured with use of a semiconductor chip.

The present invention is also directed to a radio frequency power amplifier. A radio frequency power amplifier includes the semiconductor device, at least one of the amplifier circuit and the load circuit being formed on one substrate.

The present invention can solve the conventional problem that a load impedance cannot be controlled appropriately and that an insertion loss is increased, and can provide a radio frequency circuit, a radio frequency power amplifier, and a semiconductor device which are suitable for multiband operation and/or multimode operation.

A radio frequency circuit according to the present invention, and a radio frequency power amplifier and a semiconductor device which include the radio frequency circuit, are suitable for multiband operation and/or multimode operation, and are applicable to a mobile communication apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an example of a configuration of a radio frequency circuit according to a first embodiment of the present invention;

FIG. 2 is a diagram showing an equivalent circuit, of the radio frequency circuit shown in FIG. 1, obtained in a case where a transmission line 40-1 is selected;

FIG. 3 is a schematic diagram showing an impedance conversion whose operation principle is described in the first embodiment of the present invention;

FIG. 4 is a block diagram showing an example of a configuration in which load circuits 30-1 and 30-2 are provided on paths, respectively;

FIG. 5 is a block diagram showing an example of a configuration of a radio frequency circuit according to a second embodiment of the present invention;

FIG. 6 is a block diagram showing an example of a configuration of a radio frequency circuit according to a third embodiment of the present invention;

FIG. 7 is a diagram showing a result of comparison of a collector efficiency of the amplifier circuit 10 among the first embodiment, the third embodiment, and a conventional art;

FIG. 8 is a block diagram showing an example of a configuration of a radio frequency circuit according to a fourth embodiment of the present invention;

FIG. 9 is a block diagram showing an example of a configuration of a radio frequency circuit according to a fifth embodiment of the present invention;

FIG. 10 is a block diagram showing an example of a configuration of a radio frequency circuit according to a sixth embodiment of the present invention;

FIG. 11 is a block diagram showing an example of a configuration of a radio frequency circuit according to a seventh embodiment of the present invention;

FIG. 12 is a block diagram showing an example of a configuration of a radio frequency circuit according to an eighth embodiment of the present invention;

FIG. 13 is a block diagram showing an example of a configuration of a radio frequency circuit according to a ninth embodiment of the present invention;

FIG. 14A is a waveform chart showing temporal variation of power of an amplified signal outputted from the amplifier circuit 10;

FIG. 14B is a waveform chart showing temporal variation of power of an amplified signal outputted from the amplifier circuit 10;

FIG. 15A is a characteristic diagram showing power efficiency obtained when the amplified signals shown in FIG. 14B is generated;

FIG. 15B is a characteristic diagram showing power efficiency obtained when the amplified signals shown in FIG. 1 4A is generated;

FIG. 15C is a characteristic chart showing power efficiency obtained when the upper limit of a linear operation range RLN is decreased from a peak power PB so as to be equal to or lower than a peak power PA;

FIG. 16 is a block diagram showing an example of a configuration of a radio frequency circuit according to a tenth embodiment of the present invention;

FIG. 17 is a block diagram showing an example of a configuration of a radio frequency circuit according to an eleventh embodiment of the present invention;

FIG. 18 is a diagram showing a configuration of a selection circuit disclosed in Patent Document 1.

### DESCRIPTION OF THE PREFERRED EMBODIMENTS

Hereinafter, with reference to diagrams, respective embodiments according to the present invention will be described. In the diagrams, components having substantially common configurations, operations, and effects are denoted by common reference numerals. All numeral values used in the description are given as examples for the purpose of specifically describing the present invention, and the present invention is not limited to the numeral values. Connection relationships among constituent components described in the respective embodiments are given as examples for the purpose of specifically describing the present invention, and connection relationships to realize the present invention are not limited thereto. The constituent components described in the respective embodiments are configured as hardware components and/or software components. The constituent components which can be configured as hardware components can also be configured as software components, and the constituent components which can be configured as software components can also be configured as hardware components.

### First Embodiment

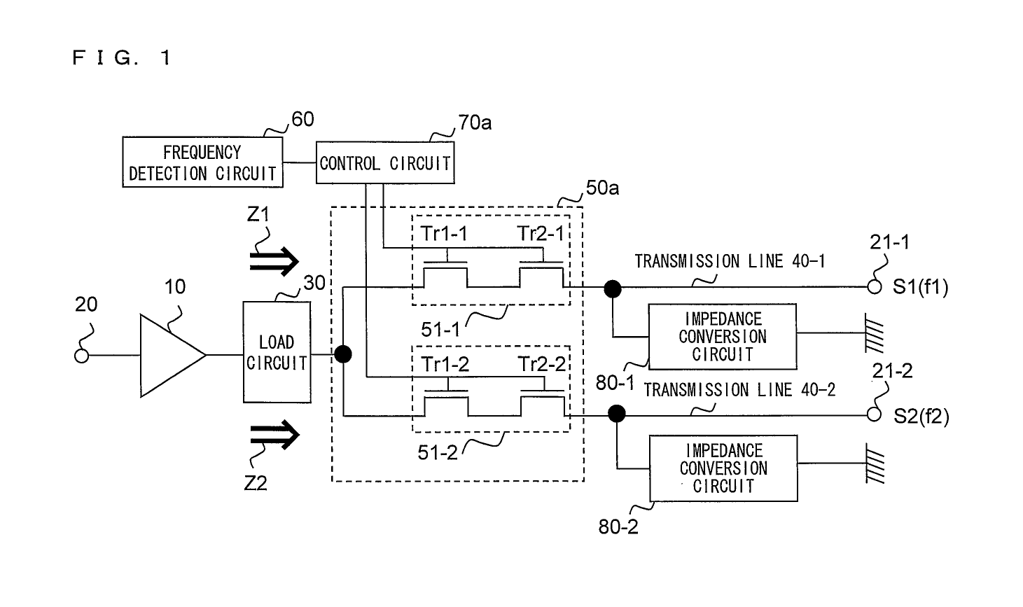

In a first embodiment, an example of a radio frequency circuit suitable for multiband operation will be described. FIG. 1 is a block diagram showing an example of a configuration of a radio frequency circuit according to the first embodiment of the present invention. In FIG. 1, the radio frequency circuit according to the present embodiment includes an amplifier circuit 10, an input terminal 20, output terminals 21-1 and 21-2, a load circuit 30, transmission lines 40-1 and 40-2, impedance conversion circuits 80-1 and 80-2, a selection circuit 50a, a frequency detection circuit 60, and a control circuit 70a.

In the example shown in FIG. 1, two kinds of frequencies are used for radio frequency signals. A radio frequency signal S1 has a frequency f1 and a radio frequency signal S2 has a frequency f2. In general, the frequency f1 and the frequency f2 are different from each other, and satisfy, for example, the relationship f1<f2. More specifically, f1 is set to 1710-1785 MHz, which includes UMTS band III, and f2 is set to 1910-1980 MHz, which includes UMTS band I. However, f1 and f2 are not limited thereto.

In addition, in the example shown in FIG. 1, the selection circuit 50a selects a transmission line in accordance with frequencies of the radio frequency signals. The radio frequency signal S1 passes through the transmission line 40-1 and the radio frequency signal S2 passes through the transmission line 40-2. Z1 represents a load impedance looking from the amplifier circuit 10 toward the output side of the amplifier circuit 10 when the transmission line 40-1 is selected. Z2 represents a load impedance looking from the amplifier circuit 10 toward the output side of the amplifier circuit 10 when the transmission line 40-2 is selected.

The amplifier circuit 10 is the final stage amplifier circuit among circuits that include amplifying elements. The amplifier circuit 10 power-amplifies a radio frequency signal inputted to the input terminal 20 by using an amplifying element and then outputs the amplified signal. The load circuit 30 is connected to the output of the amplifier circuit 10. The output of the load circuit 30 is connected to the selection circuit 50a. The transmission line 40-1 is provided between the selection circuit 50a and the output terminal 21-1, and the transmission line 40-2 is provided between the selection circuit 50a and the output terminal 21-2. Each of the output terminals 21-1 and 21-2 is connected to, for example, an antenna (not shown).

The selection circuit 50a causes an input from the load circuit 30 to be branched and outputted into two paths (a first and a second paths), i.e., has one input and two outputs. The selection circuit 50a performs switching operation based on a control signal from the control circuit 70a to render (turn ON) one of the first and the second paths conductive and block (turn OFF) the other path, so as to select one of the transmission lines 40-1 and 40-2. The selection circuit 50a includes a transistor circuit 51-1 provided between the transmission line 40-1 and the output of the load circuit 30, and the transistor circuit 51-2 provided between the transmission line 40-2 and the output of the load circuit 30. The transistor circuit 51-1 includes switching transistors Tr1-1 and Tr2-1. The switching transistors Tr1-1 and Tr2-1 are turned ON or turned OFF by a common control signal inputted from the control circuit 70a to the gate terminals of the switching transistors Tr1-1 and Tr2-1. Similarly, the transistor circuit 51-2 includes switching transistors Tr1-2 and Tr2-2. The switching transistors Tr1-2 and Tr2-2 are turned ON or turned OFF by a common control signal inputted from the control circuit 70a to the gate terminals of the switching transistors Tr1-2 and Tr2-2.

The frequency detection circuit 60 detects a frequency of an amplified signal outputted from the amplifier circuit 10. In the present embodiment, there is described an example where the frequency detection circuit 60 detects the frequency f1 when an amplified signal based on the radio frequency signal S1 is outputted, and detects the frequency f2 when an amplified signal based on the radio frequency signal S2 is outputted.

The control circuit 70a generates a control signal having selection information of a transmission line based on a frequency detected by the frequency detection circuit 60, and outputs the control signal to the selection circuit 50a. Specifically, when the frequency f1 is detected, the control circuit 70a outputs an ON signal to the transistor circuit 51-1 and outputs an OFF signal to the transistor circuit 51-2. Thus, the switching transistors Tr1-1 and Tr2-1 are turned ON, the switching transistors Tr1-2 and Tr2-2 are turned OFF. In this case, an amplified signal based on the radio frequency signal S1 passes through the load circuit 30 and then through the first path (the switching transistors Tr1-l and Tr2-1, and the transmission line 40-1), and is outputted from the output terminal 21-1. Similarly, when the frequency f2 is detected, the control circuit 70a outputs an OFF signal to the transistor circuit 51-1 and outputs an ON signal to the transistor circuit 51-2. Thus, the switching transistors Tr1-1 and Tr2-1 are turned OFF, the switching transistors Tr1-2 and Tr2-2 are turned ON. In this case, an amplified signal based on the radio frequency signal S2 passes through the load circuit 30 and then through the second path (the switching transistors Tr1-2 and Tr2-2, and the transmission line 40-2), and is outputted from the output terminal 21-2.

The impedance conversion circuit 80-1 includes a capacitance, an inductance, a resistance, a transistor, etc. One end of the impedance conversion circuit 80-1 is connected to the transmission line 40-1, and the other end is grounded. The impedance conversion circuit 80-1 converts the load impedance Z1 into a load impedance which enables maximum efficiency and maximum output power to be obtained from the amplifier circuit 10 at the frequency f1. Similarly, the impedance conversion circuit 80-2 includes a capacitance, an inductance, a resistance, a transistor, etc. One end of the impedance conversion circuit 80-2 is connected to the transmission line 40-2, and the other end is grounded. The impedance conversion circuit 80-2 converts the load impedance Z2 into a load impedance which enables maximum efficiency and maximum output power to be obtained from the amplifier circuit 10 at the frequency f2.

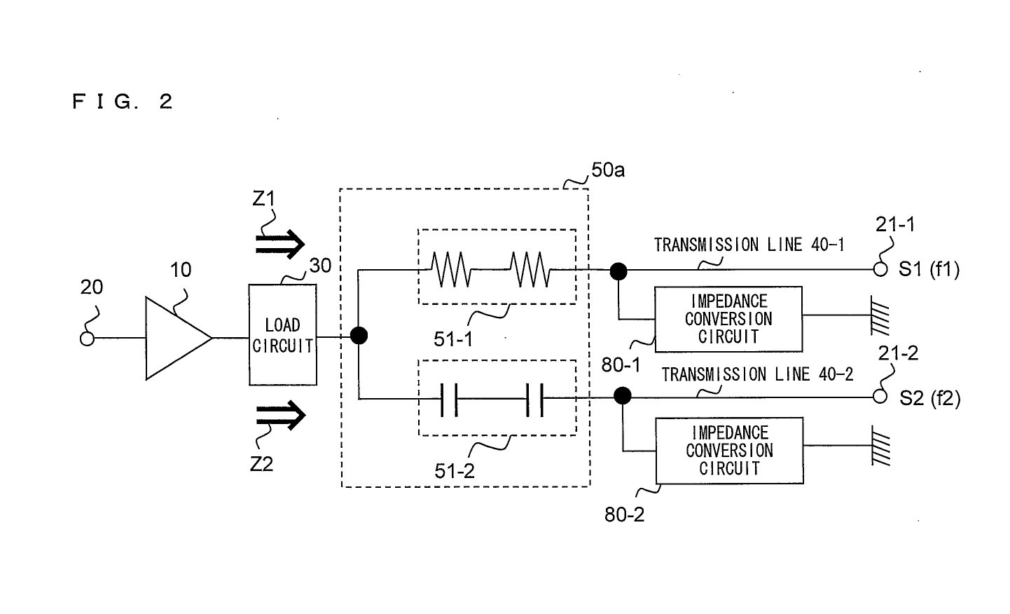

Hereinafter, with reference to FIG. 2, an operation principle of impedance conversion of the present invention will be described. FIG. 2 is an equivalent circuit diagram, of the radio frequency circuit shown in FIG. 1, obtained in a case where the transmission line 40-1 is selected.

Firstly, the load impedance Z1 will be described under the condition that the transmission line 40-1 is selected. The switching transistors Tr1-1, Tr2-1, Tr1-2, and Tr2-2 are represented as resistance elements if they are in an ON state, and are represented as capacitance elements if they are in an OFF state. Accordingly, when the transmission line 40-1 is selected as shown in FIG. 2 (when the switching transistors Tr1-1 and Tr2-1 are in an ON state and the switching transistors Tr1-2 and Tr2-2 are in an OFF state), the switching transistors Tr1-1 and Tr2-1 are represented as resistance elements and the switching transistors Tr1-2 and Tr2-2 are represented as capacitance elements. A resistance value of the resistance element (ON resistance) existing when the switching transistor is in an ON state, and a capacitance value of the capacitance element (OFF capacitance) existing when the switching transistor is in an OFF state, are constants which depend on the device size of the switching transistor being used. In the present embodiment, as an example, it is assumed that the resistance value of the ON resistance of each switching transistor is about 0.8Ω, and the capacitance value of the OFF capacitance of each switching transistor is about 0.5 pF. However, these values are not limited thereto.

In FIG. 2, the load impedance Z1 is converted by the impedance conversion circuit 80-1 into a load impedance which enables maximum efficiency and maximum output power to be obtained from the amplifier circuit 10 at the frequency f1.

It is noted that, when conversion of the load impedance Z1 is performed, although influence from the impedance conversion circuit 80-1 is significantly large as a matter of course, the impedance conversion circuit 80-2 provided on the transmission line 40-2 which corresponds to an OFF path also influences the conversion of the load impedance Z1 via the OFF capacitances. Owing to the influence from the impedance conversion circuit 80-2 provided on the OFF path, it is possible to further enhance accuracy of impedance matching. Moreover, some types of circuits (for example, series capacitance) used for the impedance conversion circuit 80-2 can cause the impedance conversion circuit 80-2 to further reduce an impedance of the OFF path, thereby enabling a leakage loss of the OFF path to be reduced. Therefore, it is expected that an insertion loss of the ON path (transmission line 40-1) is further decreased.

Next, the load impedance Z2 will be described under the condition that the transmission line 40-2 is selected. When the transmission line 40-2 is selected (when the switching transistors Tr1-1 and Tr2-1 are in an OFF state and the switching transistors Tr1-2 and Tr2-2 are in an ON state), the switching transistors Tr1-1 and Tr2-1 are represented as capacitance elements and the switching transistors Tr1-2 and Tr2-2 are represented as resistance elements. In this state, the load impedance Z2 is converted by the impedance conversion circuit 80-2 into a load impedance which enables maximum efficiency and maximum output power to be obtained from the amplifier circuit 10 at the frequency f2. Also in this case, owing to the influence from the impedance conversion circuit 80-1 provided on the OFF path, it is possible to enhance accuracy of impedance matching. Moreover, some types (for example, series capacitance) of circuits used for the impedance conversion circuit 80-1 can cause the impedance conversion circuit 80-1 to further reduce an impedance of the OFF path, thereby enabling a leakage loss of the OFF path to be reduced.

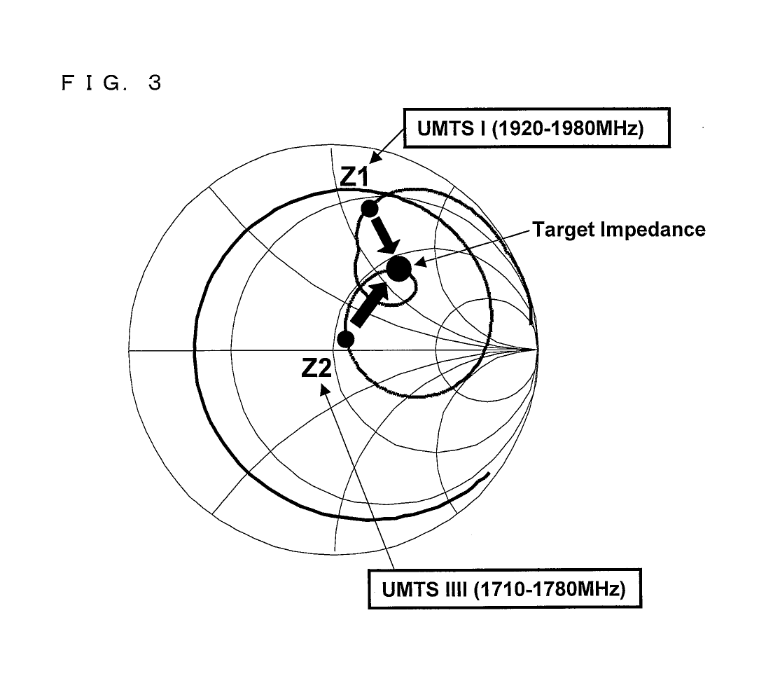

FIG. 3 is a schematic diagram showing an impedance conversion described in the above operation principle. In FIG. 3, there are shown the load impedances Z1 and Z2 which are yet to be converted, and a Target Impedance (an optimum load impedance which enables maximum efficiency and maximum output power to be obtained from the amplifier circuit 10).

The load impedances Z1 and Z2 to which conversion processing has not been performed, i.e., which have not been converted by the impedance conversion circuits 80-1 and 80-2, have different values from each other even in a case where switching transistors equivalent to each other are used for the transistor circuits 51-1 and 51-2. This is because the load circuit 30 includes, as its components, an inductance and a capacitance which vary in accordance with a frequency. The load impedance Z1 corresponding to the frequency f1 and the load impedance Z2 corresponding to the frequency f2 have different values from each other as described in FIG. 3.

As is well known, in order to optimize efficiency of the amplifier circuit 10, it is necessary to perform impedance matching so as to match an input impedance to an output impedance in respective conditions of a frequency of an amplified signal, an average voltage, and the like. Accordingly, an optimum load impedance (Target Impedance) is uniquely determined as shown in FIG. 3. Therefore, in order to realize a radio frequency circuit suitable for multiband operation, it is necessary to optimize a load impedance for each frequency of the amplified signals so as to cause the load impedance to approach the optimum load impedance (Target Impedance) shown in FIG. 3. In the present embodiment, each of the transmission lines includes one impedance conversion circuit, i.e., the transmission lines include the impedance conversion circuits 80-1 and 80-2, respectively, so as to optimize a load impedance in each transmission line, i.e., for each frequency of the amplified signals.

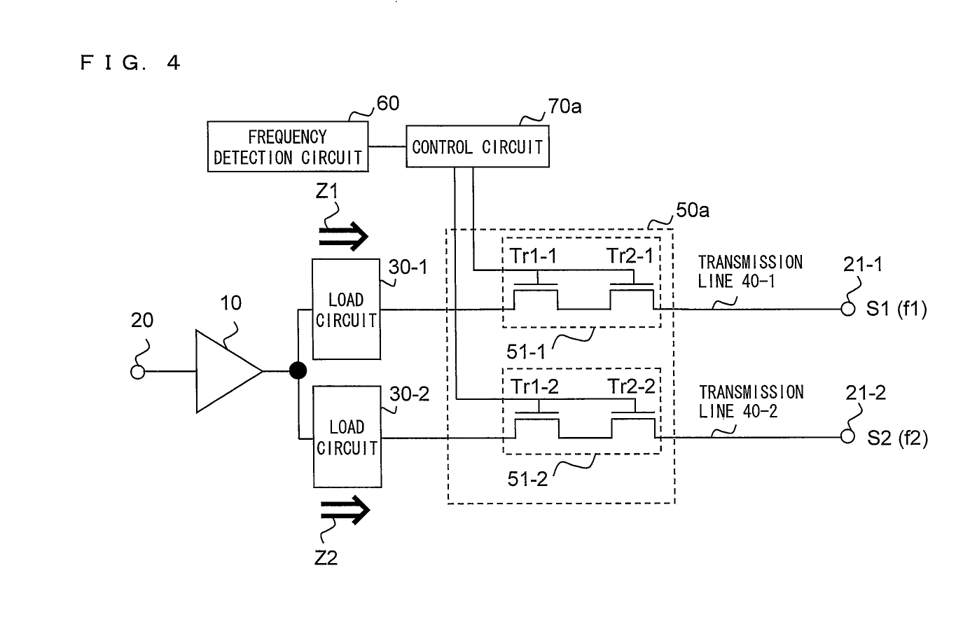

As a method for converting an impedance, it is theoretically possible to provide load circuits 30-1 and 30-2 on the paths, respectively, so as to convert load impedances Z1 and Z2, as shown in FIG. 4. However, since each of the load circuits 30-1 and 30-2 includes a capacitance formed by an SMD component, and an inductance formed by a microstrip line on a circuit board, the load circuits 30-1 and 30-2 occupy a majority of portion of the radio frequency power amplifier, resulting in a high cost. Therefore, this method is not desirable for practical purposes. On the other hand, in the present embodiment, since the transmission lines include the impedance conversion circuits 80-1 and 80-2, respectively, such a problem does not occur.

As described above, according to the first embodiment, a load impedance is optimized for each frequency of the amplified signals (that is, in each selected transmission line) by using the impedance conversion circuit 80-1 and 80-2. Therefore, even when the radio frequency circuit according to the first embodiment is used for a multiband mobile phone or the like which is operated in various radio frequency bands, it is possible to perform optimum impedance matching in accordance with various frequency bands to be used, thereby enabling the amplifier circuit 10 to be optimized for each frequency. Thus, according to the first embodiment, a radio frequency circuit suitable for multiband operation can be provided.

### Second Embodiment

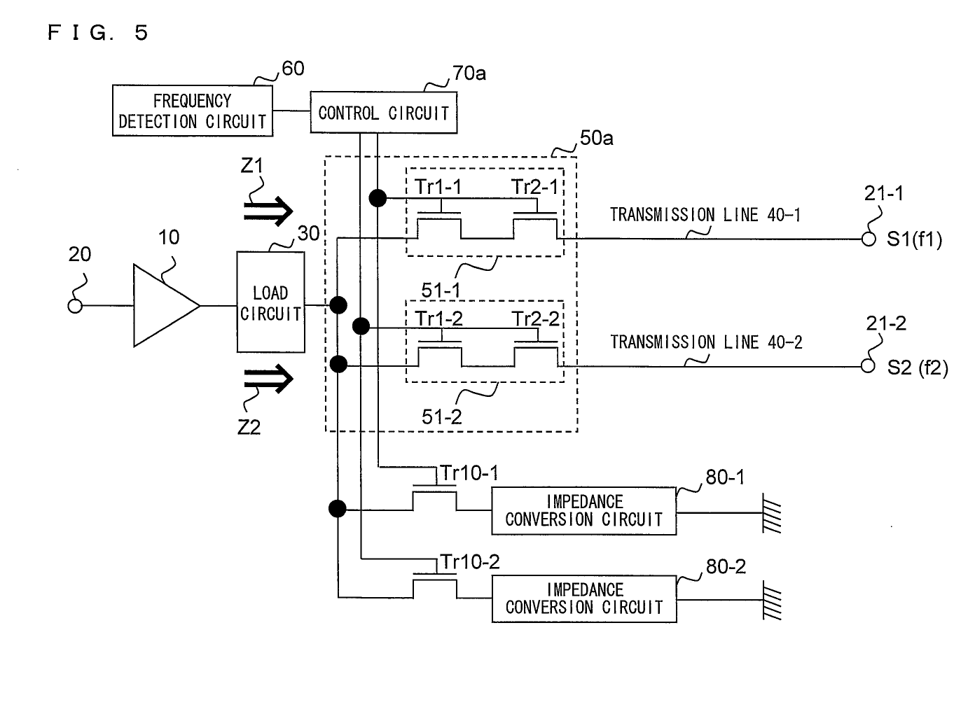

FIG. 5 is a block diagram showing an example of a configuration of a radio frequency circuit according to a second embodiment of the present invention. The radio frequency circuit according to the present embodiment is different from the radio frequency circuit according to the first embodiment shown in FIG. 1, in that the radio frequency circuit according to the present embodiment includes the impedance conversion circuits 80-1 and 80-2 between the load circuit 30 and the selection circuit 50a. Specifically, the radio frequency circuit according to the present embodiment includes the impedance conversion circuits 80-1 and 80-2 between the load circuit 30 and the selection circuit 50a, and further includes switching transistors Tr10-1 and Tr10-2. Hereinafter, differences from the first embodiment will mainly be described. The rest of the configuration of the radio frequency circuit according to the second embodiment, and the operation and effect of the rest of the configuration, are the same as those of the first embodiment, and description thereof is omitted.

As shown in FIG. 5, the impedance conversion circuit 80-1 is provided between the load circuit 30 and the selection circuit 50a. Specifically, one end of the impedance conversion circuit 80-1 is connected via the switching transistor Tr10-1 to a connection point between the load circuit 30 and the selection circuit 50a, and the other end of the impedance conversion circuit 80-1 is grounded. Similarly, the impedance conversion circuit 80-2 is provided between the load circuit 30 and the selection circuit 50a. Specifically, one end of the impedance conversion circuit 80-2 is connected via the switching transistor Tr10-2 to a connection point between the load circuit 30 and the selection circuit 50a, and the other end of the impedance conversion circuit 80-2 is grounded.

The same control signal as a control signal which is inputted to the gate terminals of the switching transistors Tr1-1 and Tr2-1 on the first path, is inputted to the switching transistor Tr10-1. Therefore, when the transmission line 40-1 is selected, the switching transistor Tr10-1 is turned ON as well as the switching transistors Tr1-1 and Tr2-1 on the first paths, and when the transmission line 40-2 is selected, the switching transistor Tr10-1 is turned OFF as well as the switching transistors Tr1-1 and Tr2-1 on the first paths. Similarly, the same control signal as a control signal which is inputted to the gate terminals of the switching transistors Tr1-2 and Tr2-2 on the second path, is inputted to the switching transistor Tr10-2. Therefore, when the transmission line 40-1 is selected, the switching transistor Tr10-2 is turned OFF as well as the switching transistors Tr1-2 and Tr2-2 on the second paths, and when the transmission line 40-2 is selected, the switching transistor Tr10-2 is turned ON as well as the switching transistors Tr1-2 and Tr2-2 on the second paths.

The radio frequency circuit having the above configuration according to the second embodiment also enables a load impedance to be optimized for each frequency of the amplified signals.

Moreover, according to the second embodiment, the resistance element existing when the transistor circuits 51-1 and 51-2 are in an ON state, and the capacitance element existing when the transistor circuits 51-1 and 51-2 are in an OFF state, have smaller influence on the impedance conversion circuits 80-1 and 80-2 than those of the first embodiment do. Therefore, impedance conversion is facilitated in comparison with a case of the first embodiment, and a radio frequency circuit having an excellent efficiency characteristic over a wide band can be provided.

In the above description, the radio frequency circuit has two paths. However, the radio frequency circuit may have three or more paths. In this case, corresponding to 1st to n-th (n is an integer equal to or more than 3) paths, there are provided transmission lines 40-1 to 40-n, output terminals 21-1 to 21-n, transistor circuits 51-1 to 51-n, impedance conversion circuits 80-1 to 80-n, and switching transistors Tr10-1 to Tr10-n, respectively. In addition, the impedance conversion circuit 80-n is provided between the load circuit 30 and the selection circuit 50a, one end of the impedance conversion circuit 80-n is connected via the switching transistor Tr10-n to a connection point between the load circuit 30 and the selection circuit 50a, and the other end of the impedance conversion circuit 80-n is grounded.

### Third Embodiment

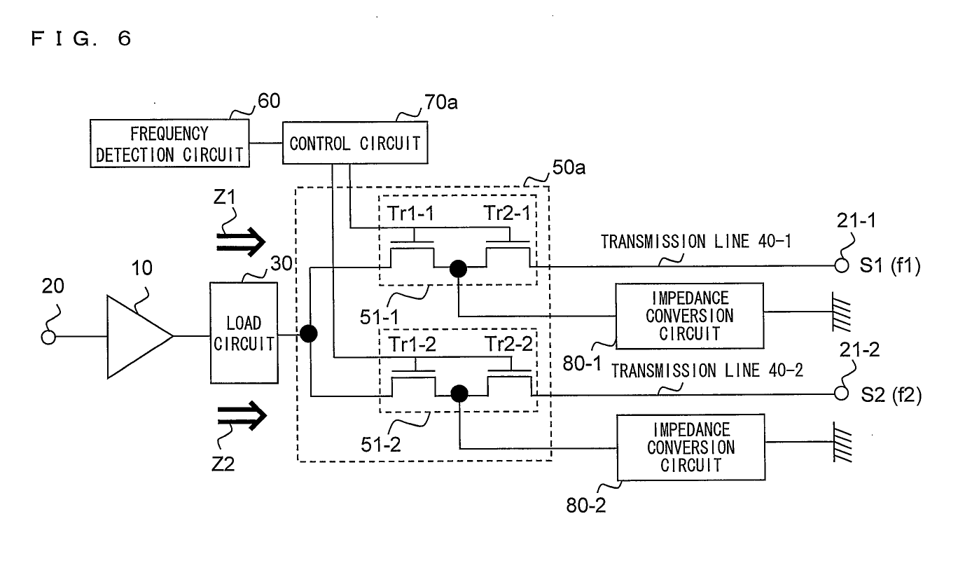

FIG. 6 is a block diagram showing an example of a configuration of a radio frequency circuit according to a third embodiment of the present invention. The radio frequency circuit according to the present embodiment is different from the radio frequency circuit shown in FIG. 1 according to the first embodiment, in that the radio frequency circuit according to the present embodiment includes the impedance conversion circuits 80-1 and 80-2 between transistors included in the transistor circuits 51-1 and 51-2, respectively. Specifically, the radio frequency circuit according to the third embodiment includes the impedance conversion circuits 80-1 between the switching transistors Tr1-1 and Tr2-1 on the first path, and the impedance conversion circuits 80-2 between the switching transistors Tr1-2 and Tr2-2 on the second path. Hereinafter, differences from the first embodiment will mainly be described. The rest of the configuration of the radio frequency circuit according to the third embodiment, and the operation and effect of the rest of the configuration, are the same as those of the first embodiment, and description thereof is omitted.

As shown FIG. 6, the impedance conversion circuit 80-1 is provided between the switching transistors Tr1-1 and Tr2-1 on the first path. Specifically, one end of the impedance conversion circuit 80-1 is connected to a connection point between the switching transistors Tr1-1 and Tr2-1 on the first path, and the other end of the impedance conversion circuit 80-1 is grounded. Similarly, the impedance conversion circuit 80-2 is provided between the switching transistors Tr1-2 and Tr2-2 on the second path. Specifically, one end of the impedance conversion circuit 80-2 is connected to a connection point between the switching transistors Tr1-2 and Tr2-2 on the second path, and the other end of the impedance conversion circuit 80-2 is grounded

The radio frequency circuit having the above configuration according to the third embodiment also enables a load impedance to be optimized for each frequency of the amplified signals.

Moreover, according to the third embodiment, the resistance element existing when the transistor circuits 51-1 and 51-2 are in an ON state, and the capacitance element existing when the transistor circuits 51-1 and 51-2 are in an OFF state, have smaller influence on the impedance conversion circuits 80-1 and 80-2 than those of the first embodiment do, owing to the difference in the positions of the impedance conversion circuits, that is, owing to the fact that each of the impedance conversion circuits 80-1 and 80-2 is provided between the switching transistors included in each of the transistor circuits. Therefore, impedance conversion is facilitated in comparison with a case of the first embodiment, and a radio frequency circuit having an excellent efficiency characteristic over a wide band can be provided.

Hereinafter, the grounds regarding the radio frequency circuit according to the third embodiment having an excellent efficiency characteristic over a wide band will be described.

Firstly, an insertion loss of an ON path of the first embodiment and an insertion loss of an ON path of the third embodiment are calculated to be compared with each other. As a calculation condition, it is assumed that the selection circuit 50a is an SPDT (single-pole/double-throw) circuit, a resistance value of each of the ON resistances is 2.0Ω, a capacitance of each of the OFF capacitances is 0.6 pF, an impedance of each of the amplifier circuits 10 is 3Ω, and a frequency of 2 GHz is used.

In a case where it is desired that a load impedance of each of the ON paths is adjusted to 3Ω by using the impedance conversion circuit, in the third embodiment, a capacitance value of the impedance conversion circuit is set to 1.1 pF, thereby enabling the load impedance of the ON path to be adjusted to 2.81-j0.15[Ω]. On the other hand, in the first embodiment, a capacitance value of the impedance conversion circuit is set to 1.6 pF, thereby enabling the load impedance of the ON path to be adjusted to 3.01-j0.01[Ω]. In this case, calculating an insertion loss of each of the ON paths obtains a result that, in the third embodiment, an insertion loss is 0.59 dB, and, in the first embodiment, an insertion loss is 0.97 dB.

Thus, in the third embodiment, impedance conversion efficiency is increased in comparison with that in the first embodiment, thereby enabling the size of the impedance conversion circuit on a semiconductor chip to be decreased by 30% and an insertion loss of an ON path to be decreased by about 0.35 dB. In addition, by calculating an insertion loss of an OFF path of the third embodiment, it is obvious that, in a case where the impedance conversion circuit does not exist in an OFF path, an insertion loss is increased by about 0.1 dB in comparison with a case where the impedance conversion circuit exists in an OFF path. Thus, in view of an insertion loss of an ON path and an insertion loss of an OFF path, it is obvious that the radio frequency circuit according to the third embodiment has an excellent efficiency characteristic and provides the effect that the area of a chip including the radio frequency circuit can be decreased.

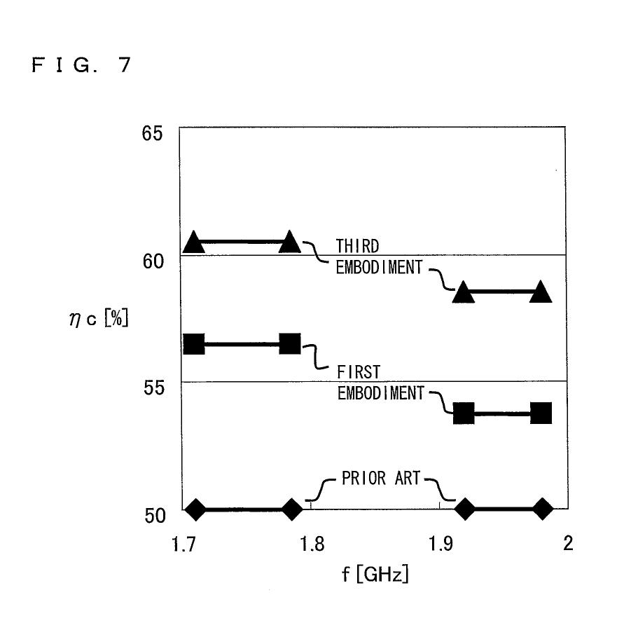

Next, a collector efficiency of the amplifier circuit 10 of the first embodiment is compared with a collector efficiency of the amplifier circuit 10 of the third embodiment. FIG. 7 is a diagram showing a result of comparison of a collector efficiency of the amplifier circuit 10 among the first embodiment, the third embodiment, and conventional art. In the first embodiment, a collector efficiency ηc is improved in both UMTS band III and UMTS band I in comparison with a collector efficiency ηc (which is assumed to be 50% as an example) obtained in a case of the prior art. Moreover, in the third embodiment, a collector efficiency ηc is more improved than in the first embodiment. This is because, as previously described, the resistance element existing when the transistor circuits 51-1 and 51-2 are in an ON state, and the capacitance element existing when the transistor circuits 51-1 and 51-2 are in an OFF state, have smaller influence on the impedance conversion circuits 80-1 and 80-2 than those of the first embodiment do. Thus, in view of a collector efficiency of the amplifier circuit 10, it is obvious that the radio frequency circuit according to the third embodiment has an excellent efficiency characteristic over a wide band.

### Fourth Embodiment

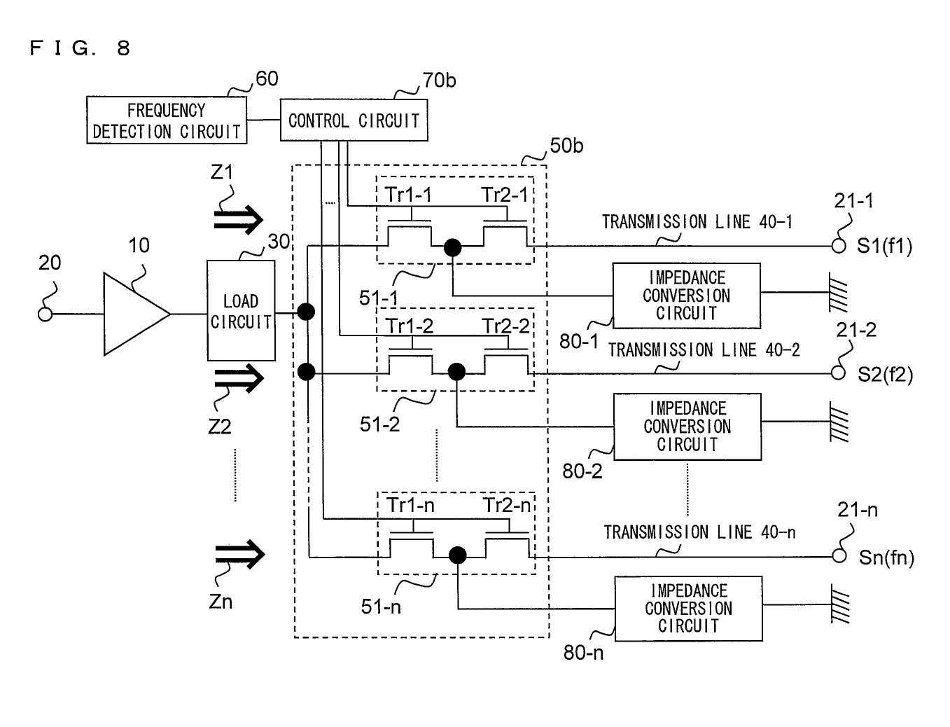

FIG. 8 is a block diagram showing an example of a configuration of a radio frequency circuit according to a fourth embodiment of the present invention. The radio frequency circuit according to the present embodiment is different from the radio frequency circuit shown in FIG. 6 according to the third embodiment, in that the radio frequency circuit according to the present embodiment includes three or more paths. Specifically, the radio frequency circuit according to the present embodiment includes a selection circuit 50b in place of the selection circuit 50a, and a control circuit 70b in place of the control circuit 70a, and further includes a transmission lines 40-3 to 40-n (n is an integer equal to or more than 3), impedance conversion circuits 80-3 to 80-n, and output terminals 21-3 to 21-n. Moreover, in the radio frequency circuit according to the present embodiment, n kinds of frequencies are used for radio frequency signals, a radio frequency signal Sn has a frequency fn, and Zn represents a load impedance looking from the amplifier circuit 10 toward the output side of the amplifier circuit 10 when the transmission line 40-n is selected. Hereinafter, differences from the third embodiment will mainly be described. The rest of the configuration of the radio frequency circuit according to the present embodiment, and the operation and effect of the rest of the configuration, are the same as those of the third embodiment, and description thereof is omitted.

The selection circuit 50b causes an input from the load circuit 30 to be branched and outputted into n paths (1st to n-th paths), i.e., is an SPnT (Single-Pole/n-throw) circuit which has one input and n outputs. The selection circuit 50b performs switching operation based on a control signal from the control circuit 70b to render (turn ON) one of the 1st to n-th paths conductive and block (turn OFF) the other paths, so as to select one of the transmission lines 40-1 to 40-n. The selection circuit 50b includes a transistor circuits 51-1 to 51-n provided on the 1st to n-th paths, respectively. The transistor circuit 51-n includes switching transistors Tr1-n and Tr2-n. The switching transistors Tr1-n and Tr2-n are turned ON or turned OFF by a common control signal inputted from the control circuit 70b to the gate terminals of the switching transistors Tr1-n and Tr2-n.

The control circuit 70b generates a control signal having selection information of a transmission line based on a frequency detected by the frequency detection circuit 60, and outputs the control signal to the selection circuit 50b. For example, when the frequency f1 is detected by the frequency detection circuit 60, the control circuit 70b outputs an ON signal to the transistor circuit 51-1 and outputs an OFF signal to the transistor circuits 51-2 to 51-n.

The impedance conversion circuit 80-n is provided between the switching transistors Tr1-n and Tr2-n on the n-th path. Specifically, one end of the impedance conversion circuit 80-n is connected to a connection point between the switching transistors Tr1-n and Tr2-n on the n-th path, and the other end of the impedance conversion circuit 80-n is grounded. The impedance conversion circuit 80-n converts the load impedance Zn into a load impedance which enables maximum efficiency and maximum output power to be obtained from the amplifier circuit 10 at the frequency fn.

According to the fourth embodiment described above, owing to increase in number of the paths (transmission lines), it becomes possible to increase the kinds of frequencies of amplified signals for which a load impedance can be optimized. Therefore, a radio frequency circuit according to the fourth embodiment is particularly suitable for a mobile phone and the like in which multiband operation using many kinds of radio frequency signals is performed.

It is noted that, although the impedance conversion circuit 80-n is provided between the switching transistors Tr1-n and Tr2-n in the above description, the radio frequency circuit according to the fourth embodiment is not limited thereto. For example, the impedance conversion circuit 80-n may be connected to the transmission line 40-n.

### Fifth Embodiment

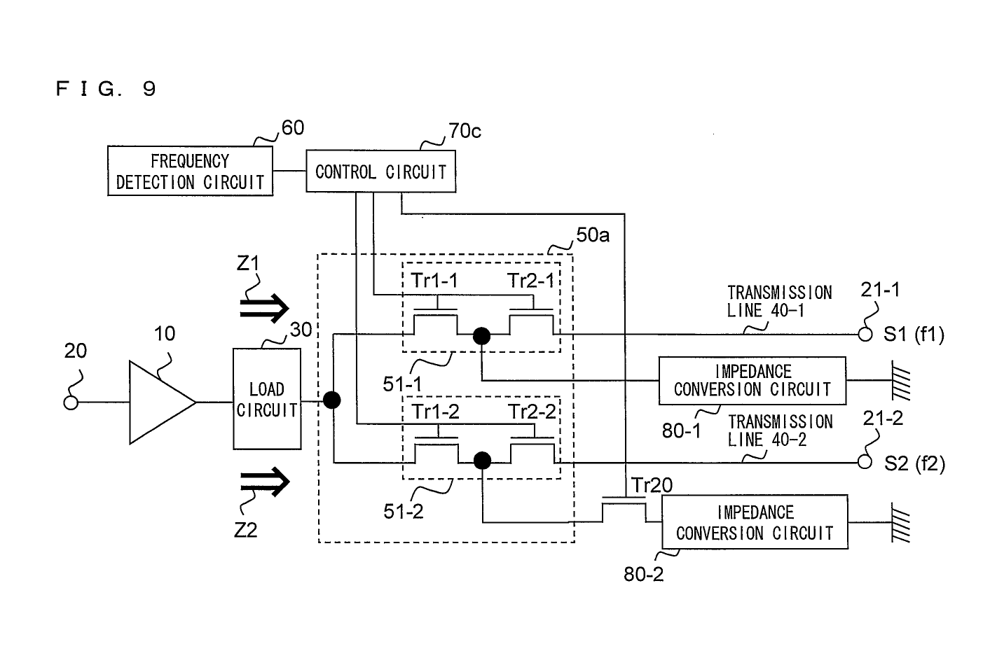

FIG. 9 is a block diagram showing an example of a configuration of a radio frequency circuit according to a fifth embodiment of the present invention. The radio frequency circuit according to the present embodiment is different from the radio frequency circuit shown in FIG. 6 according to the third embodiment, in that the radio frequency circuit according to the present embodiment includes a control circuit 70c in place of the control circuit 70a, and further includes a switching transistor Tr20. Hereinafter, differences from the third embodiment will mainly be described. The rest of the configuration of the radio frequency circuit according to the present embodiment, and the operation and effect of the rest of the configuration, are the same as those of the third embodiment, and description thereof is omitted.

In the below description, when the transmission line 40-2 is selected, the impedance conversion circuit 80-1 on an OFF path (the first path) can convert the load impedance Z2 into a load impedance which enables maximum efficiency and maximum output power to be obtained from the amplifier circuit 10 at the frequency f2, without causing the impedance conversion circuit 80-2 to perform impedance conversion.

The switching transistor Tr20 is provided between the impedance conversion circuit 80-2 and the connection point that exists between the switching transistors Tr1-2 and Tr2-2.

The control circuit 70c generates a control signal having selection information of a transmission line based on a frequency detected by the frequency detection circuit 60, and outputs the control signal to the selection circuit 50a. Specifically, when the frequency f1 is detected by the frequency detection circuit 60, the control circuit 70c outputs an ON signal to both the transistor circuit 51-1 and the switching transistor Tr20, and outputs an OFF signal to the transistor circuit 51-2. Thus, the switching transistors Tr1-1 and Tr2-1 on the first path, and the switching transistor Tr20 are turned ON, the switching transistors Tr1-2 and Tr2-2 on the second path are turned OFF. In this case, the impedance conversion circuit 80-1 on an ON path (the first path) and the impedance conversion circuit 80-2 on an OFF path (the second paths) convert the load impedance Z1 into a load impedance which enables maximum efficiency and maximum output power to be obtained from the amplifier circuit 10 at the frequency f1.

When the frequency f2 is detected, the control circuit 70c outputs an OFF signal to both the transistor circuit 51-1 and the switching transistor Tr20, and outputs an ON signal to the transistor circuit 51-2. Thus, the switching transistors Tr1-1 and Tr2-1 on the first path, and the switching transistor Tr20 are turned OFF, the switching transistors Tr1-2 and Tr2-2 on the second path are turned ON. In this case, only the impedance conversion circuit 80-1 on an OFF path (the first path) converts the load impedance Z2 into a load impedance which enables maximum efficiency and maximum output power to be obtained from the amplifier circuit 10 at the frequency f2.

The radio frequency circuit having the above configuration according to the fifth embodiment also enables a load impedance to be optimized for each frequency of the amplified signals.

It is noted that, although, in the above description, the impedance conversion circuit 80-1 is provided between the switching transistors Tr1-1 and Tr2-1 on the first path, and the impedance conversion circuit 80-2 is provided between the switching transistors Tr1-2 and Tr2-2 on the second path, the radio frequency circuit according to the fifth embodiment is not limited thereto. For example, the impedance conversion circuits 80-1 and 80-2 may be connected to the transmission lines 40-1 and 40-2, respectively.

### Sixth Embodiment

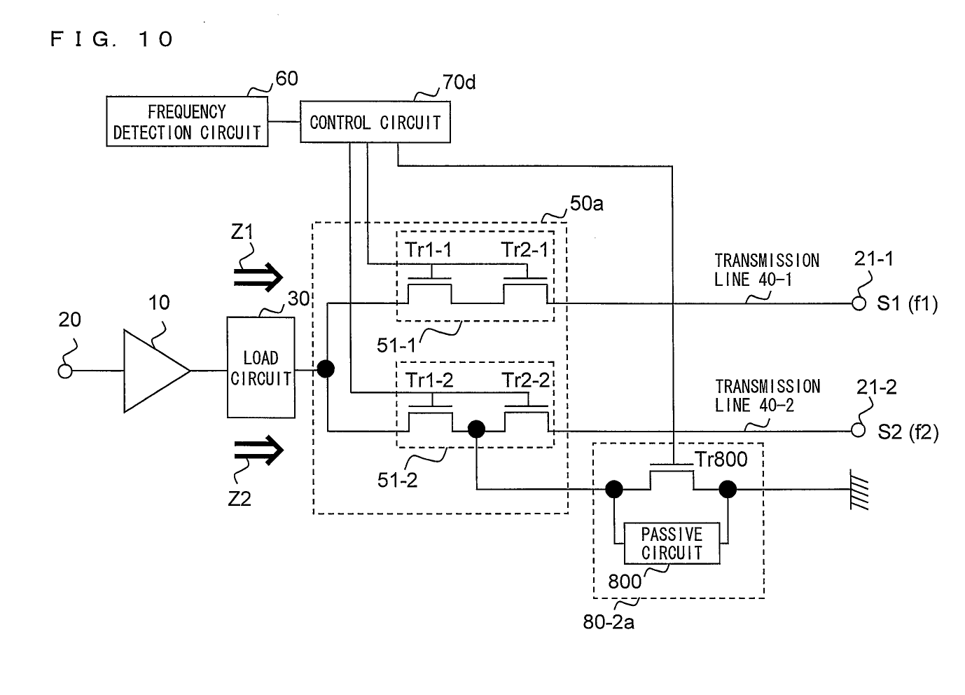

FIG. 10 is a block diagram showing an example of a configuration of a radio frequency circuit according to a sixth embodiment of the present invention. The radio frequency circuit according to the present embodiment is different from the radio frequency circuit shown in FIG. 6 according to the third embodiment, in that the radio frequency circuit according to the present embodiment does not include the impedance conversion circuit 80-1, and includes an impedance conversion circuit 80-2a in place of the impedance conversion circuit 80-2, and a control circuit 70d in place of the control circuit 70a. Hereinafter, differences from the third embodiment will mainly be described. The rest of the configuration of the radio frequency circuit according to the sixth embodiment, and the operation and effect of the rest of the configuration, are the same as those of the third embodiment, and description thereof is omitted.

The impedance conversion circuit 80-2a is provided between the switching transistors Tr1-2 and Tr2-2 on the second path. Specifically, one end of the impedance conversion circuit 80-2a is connected to a connection point between the switching transistors Tr1-2 and Tr2-2 on the second path, and the other end of the impedance conversion circuit 80-2a is grounded. The impedance conversion circuit 80-2a includes a passive circuit 800 and a switching transistor Tr800, and a control signal from the control circuit 70d is inputted to the gate terminal of the switching transistor Tr800.

The control circuit 70d generates a control signal having selection information of a transmission line based on a frequency detected by the frequency detection circuit 60, and outputs the control signal to the selection circuit 50a. Specifically, when the frequency f1 is detected by the frequency detection circuit 60, the control circuit 70d outputs an ON signal to both the transistor circuit 51-1 and the switching transistor Tr800, and outputs an OFF signal to the transistor circuit 51-2. Thus, the switching transistors Tr1-1 and Tr2-1 on the first path and the switching transistor Tr800 are turned ON, the switching transistors Tr1-2 and Tr2-2 on the second path are turned OFF. In this case, an OFF capacitance of the switching transistors Tr1-2 on an OFF path (the second path) causes a load impedance Z1 to be converted into a load impedance which enables maximum efficiency and maximum output power to be obtained from the amplifier circuit 10 at the frequency f1.

When the frequency f2 is detected by the frequency detection circuit 60, the control circuit 70d outputs OFF signals to both the transistor circuit 51-1 and the switching transistor Tr800, and outputs an ON signal to the transistor circuit 51-2. Thus, the switching transistors Tr1-1 and Tr2-1 on the first path and the switching transistor Tr800 are turned OFF, the switching transistors Tr1-2 and Tr2-2 on the second path are turned ON. In this case, the passive circuit 800 connected to an ON path (the second path) converts the load impedance Z2 into a load impedance which enables maximum efficiency and maximum output power to be obtained from the amplifier circuit 10 at the frequency f2.

The radio frequency circuit having the above configuration according to the sixth embodiment also enables a load impedance to be optimized for each frequency of the amplified signals.

In addition, the radio frequency circuit according to the sixth embodiment includes a smaller number of the impedance conversion circuit than that in a case of the third embodiment, thereby enabling the area occupied by the radio frequency circuit to be reduced.

It is noted that, although the impedance conversion circuit 80-2a is provided between the switching transistors Tr1-2 and Tr2-2 on the second path, the radio frequency circuit according to the sixth embodiment is not limited thereto. For example, the impedance conversion circuits 80-2a may be connected to the transmission line 40-2.

### Seventh Embodiment

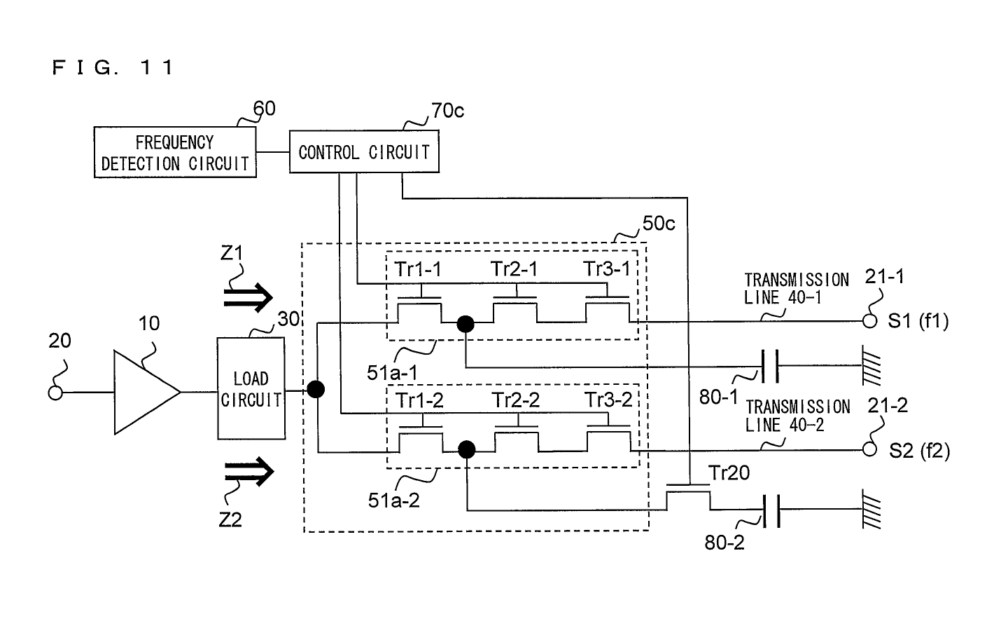

FIG. 11 is a block diagram showing an example of a configuration of a radio frequency circuit according to a seventh embodiment of the present invention. The radio frequency circuit according to the present embodiment is different from the radio frequency circuit shown in FIG. 9 according to the fifth embodiment, in that the radio frequency circuit according to the present embodiment includes a selection circuit 50c in place of the selection circuit 50a, and in that each of the impedance conversion circuits 80-1 and 80-2 of the present embodiment is formed by a series capacitance. Hereinafter, differences from the fifth embodiment will mainly be described. The rest of the configuration of the radio frequency circuit according to the seventh embodiment, and the operation and effect of the rest of the configuration, are the same as those of the fifth embodiment, and description thereof is omitted.

The selection circuit 50c includes a transistor circuit 51a-1 provided on the first path and a transistor circuit 51a-2 provided on the second path. The transistor circuit 51a-1 includes switching transistors Tr1-1 to Tr3-1. The switching transistors Tr1-1 to Tr3-1 are turned ON or turned OFF by a common control signal inputted from the control circuit 70c to the gate terminals of the switching transistors Tr1-1 to Tr3-1. Similarly, the transistor circuit 51a-2 includes the switching transistors Tr1-2 to Tr3-2. The switching transistors Tr1-2 to Tr3-2 are turned ON or turned OFF by a common control signal inputted from the control circuit 70c to the gate terminals of the switching transistors Tr1-2 to Tr3-2.

The impedance conversion circuits 80-1 and 80-2 are formed by series capacitances which have capacitance values different from each other. Specifically, an example of the capacitance values of the series capacitances is about 1 pF. However, these capacitance values are not limited thereto. Moreover, an inductance, a resistance or a FET may also be used instead of a series capacitance, for the impedance conversion circuits 80-1 and 80-2. However, any circuit configuration that can convert load impedances Z1 and Z2 can be adopted.

The radio frequency circuit having the above configuration according to the seventh embodiment also enables a load impedance to be optimized for each frequency of the amplified signals.

It is noted that, although the transistor circuit 51a-1 includes three stages of switching transistors (Tr1-1 to Tr3-1), and the transistor circuit 51a-2 includes three stages of switching transistors (Tr1-2 to Tr3-2), the radio frequency circuit according to the seventh embodiment is not limited thereto. Each of the transistor circuits 51a-1 and 51a-2 may include four or more stages of switching transistors.

### Eighth Embodiment

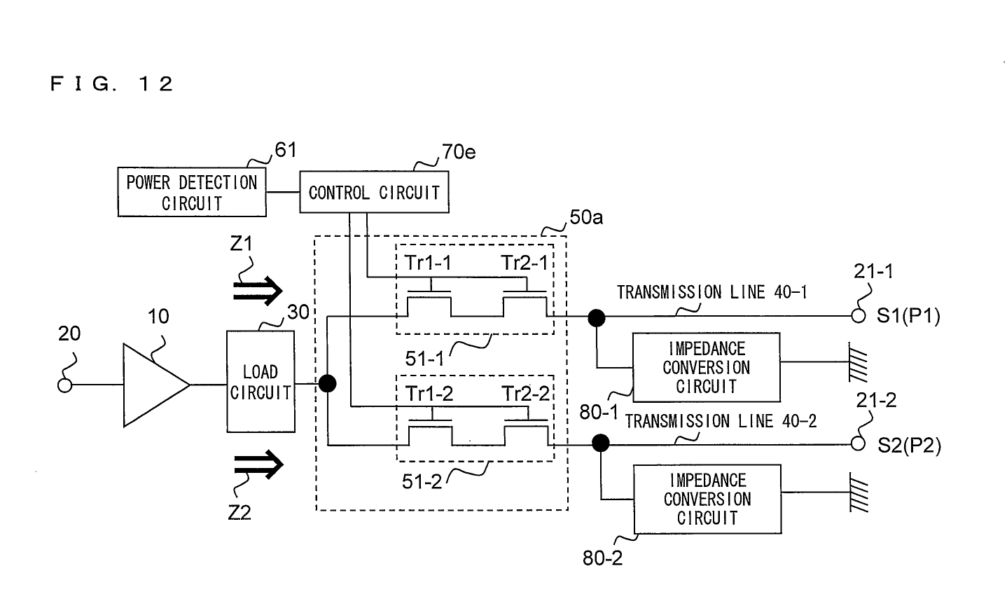

In an eighth embodiment, an example of a radio frequency circuit suitable for multimode operation will be described. FIG. 12 is a block diagram showing an example of a configuration of a radio frequency circuit according to the eighth embodiment of the present invention. The radio frequency circuit according to the present embodiment is different from the radio frequency circuit shown in FIG. 1 according to the first embodiment, in that the radio frequency circuit according to the present embodiment includes a power detection circuit 61 in place of the frequency detection circuit 60, and a control circuit 70e in place of the control circuit 70a, and in that the transmission lines are selected in accordance with an average power of an amplified signal. Hereinafter, differences from the first embodiment will mainly be described. The rest of the configuration of the radio frequency circuit according to the eighth embodiment, and the operation and effect of the rest of the configuration, are the same as those of the first embodiment, and description thereof is omitted.

In the example shown in FIG. 12, two kinds of average powers are used for radio frequency signals. A radio frequency signal S1 has an average power P1 and a radio frequency signal S2 has an average power P2. In general, the average power P1 and the average power P2 are different from each other, and satisfy, for example, the relationship P1<P2. In addition, in the example shown in FIG. 12, the selection circuit 50a selects a transmission line in accordance with an average power of the radio frequency signal. The radio frequency signal S1 passes through the transmission line 40-1 and the radio frequency signal S2 passes through the transmission line 40-2.

The power detection circuit 61 detects an average power of an amplified signal outputted from the amplifier circuit 10. In the present embodiment, there is described an example where the power detection circuit 61 detects the average power P1 when an amplified signal based on the radio frequency signal S1 is outputted, and detects the power P2 when an amplified signal based on the radio frequency signal S2 is outputted.

The control circuit 70e generates a control signal having selection information of a transmission line based on an average power detected by the power detection circuit 61, and outputs the control signal to the selection circuit 50a. Specifically, when the average power P1 is detected by the power detection circuit 61, the control circuit 70e outputs an ON signal to the transistor circuit 51-1 and outputs an OFF signal to the transistor circuit 51-2. Thus, the switching transistors Tr1-1 and Tr2-1 on the first path are turned ON, the switching transistors Tr1-2 and Tr2-2 on the second path are turned OFF. In this case, the radio frequency signal S1 which has been amplified in the amplifier circuit 10 passes through the load circuit 30 and then through the first path (the switching transistors Tr1-1 and Tr2-1, and the transmission line 40-1), and is outputted from the output terminal 21-1. Similarly, when the average power P2 is detected by the frequency detection circuit 61, the control circuit 70e outputs an OFF signal to the transistor circuit 51-1 and outputs an ON signal to the transistor circuit 51-2. Thus, the switching transistors Tr1-1 on the first path and Tr2-1 are turned OFF, the switching transistors Tr1-2 and Tr2-2 on the second path are turned ON. In this case, the radio frequency signal S2 which has been amplified in the amplifier circuit 10 passes through the load circuit 30 and then through the second path (the switching transistors Tr1-2 and Tr2-2, and the transmission line 40-2), and is outputted from the output terminal 21-2.

The impedance conversion circuit 80-1 converts the load impedance Z1 into a load impedance which enables maximum efficiency and maximum output power to be obtained from the amplifier circuit 10 at the average power P1. The impedance conversion circuit 80-2 converts the load impedance Z2 into a load impedance which enables maximum efficiency and maximum output power to be obtained from the amplifier circuit 10 at the average power P2.

As described above, according to the eighth embodiment, a load impedance is optimized for each average power of the amplified signals (that is, in each selected transmission line) by using the impedance conversion circuit 80-1 and 80-2. Therefore, even when the radio frequency circuit according to the eighth embodiment is used for a multimode mobile phone or the like which is operated in multiple kinds of communication modes, it is possible to perform optimum impedance matching in accordance with each average power of the amplified signals which are used in different communication modes from each other, thereby enabling the amplifier circuit 10 to be optimized for each average power. Thus, according to the eighth embodiment, a radio frequency circuit suitable for multimode operation can be provided.

It is noted that, although the radio frequency circuit according to the eighth embodiment is obtained by altering the radio frequency circuit according to the first embodiment so as to enable multimode operation to be performed instead of multiband operation, the radio frequency circuit according to the eighth embodiment is not limited thereto. The radio frequency circuit according to any of the second to seventh embodiments may be altered so as to enable multimode operation to be performed instead of multiband operation.

### Ninth Embodiment

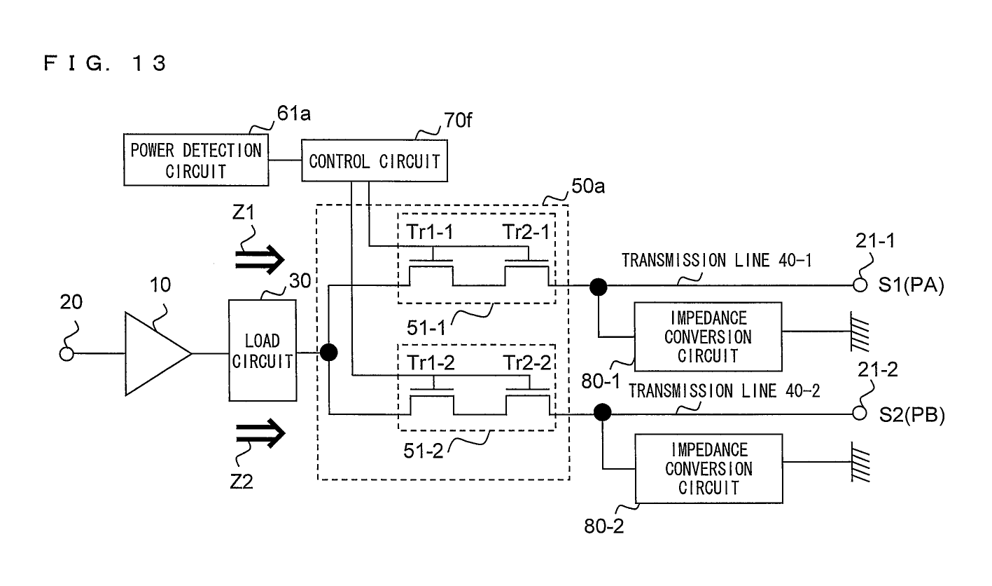

FIG. 13 is a block diagram showing an example of a configuration of a radio frequency circuit according to a ninth embodiment of the present invention. The radio frequency circuit according to the present embodiment is different from the radio frequency circuit shown in FIG. 1 according to the first embodiment, in that the radio frequency circuit according to the present embodiment includes a power detection circuit 61a in place of the frequency detection circuit 60, and a control circuit 70f in place of the control circuit 70a, and in that the transmission lines are selected in accordance with a peak power of an amplified signal. Hereinafter, differences from the first embodiment will mainly be described. The rest of the configuration of the radio frequency circuit according to the ninth embodiment, and the operation and effect of the rest of the configuration, are the same as those of the first embodiment, and description thereof is omitted.

In the example shown in FIG. 13, two kinds of peak powers are used for radio frequency signals. A radio frequency signal S1 has a peak power PA and a radio frequency signal S2 has a peak power PB. In general, the peak power PA and the peak power PB are different from each other, and satisfy, for example, the relationship PA<PB. In addition, in the example shown in FIG. 13, the selection circuit 50a selects a transmission line in accordance with peak power of the radio frequency signal. The radio frequency signal S1 passes through the transmission line 40-1 and the radio frequency signal S2 passes through the transmission line 40-2.

The power detection circuit 61a detects a peak power of an amplified signal outputted from the amplifier circuit 10. In the present embodiment, there is described an example where the power detection circuit 61a detects the peak power PA when an amplified signal based on the radio frequency signal S1 is outputted, and detects the peak power PB when an amplified signal based on the radio frequency signal S2 is outputted.

The control circuit 70f generates a control signal having selection information of a transmission line based on the peak power detected by the power detection circuit 61a, and outputs the control signal to the selection circuit 50a. Specifically, when the peak power PA is detected by the power detection circuit 61a, the control circuit 70f outputs an ON signal to the transistor circuit 51-1 and outputs an OFF signal to the transistor circuit 51-2. Thus, the switching transistors Tr1-1 and Tr2-1 on the first path are turned ON, the switching transistors Tr1-2 and Tr2-2 on the second path are turned OFF. In this case, the radio frequency signal S1 which has been amplified in the amplifier circuit 10 passes through the load circuit 30 and then through the first path (the switching transistors Tr1-1 and Tr2-1, and the transmission line 40-1), and is outputted from the output terminal 21-1. Similarly, when the peak power PB is detected by the power detection circuit 61a, the control circuit 70f outputs an OFF signal to the transistor circuit 51-1 and outputs an ON signal to the transistor circuit 51-2. Thus, the switching transistors Tr1-1 and Tr2-1 on the first path are turned OFF, the switching transistors Tr1-2 and Tr2-2 on the second path are turned ON. In this case, the radio frequency signal S2 which has been amplified in the amplifier circuit 10 passes through the load circuit 30 and then through the second path (the switching transistors Tr1-2 and Tr2-2, and the transmission line 40-2), and is outputted from the output terminal 21-2.

The impedance conversion circuit 80-1 converts the load impedance Z1 into a load impedance which enables maximum efficiency and maximum output power to be obtained from the amplifier circuit 10 at the peak power PA. The impedance conversion circuits 80-2 converts the load impedance Z2 into a load impedance which enables maximum efficiency and maximum output power to be obtained from the amplifier circuit 10 at the peak power PB. Hereinafter, a specific example of impedance conversion performed by the impedance conversion circuits will be described.

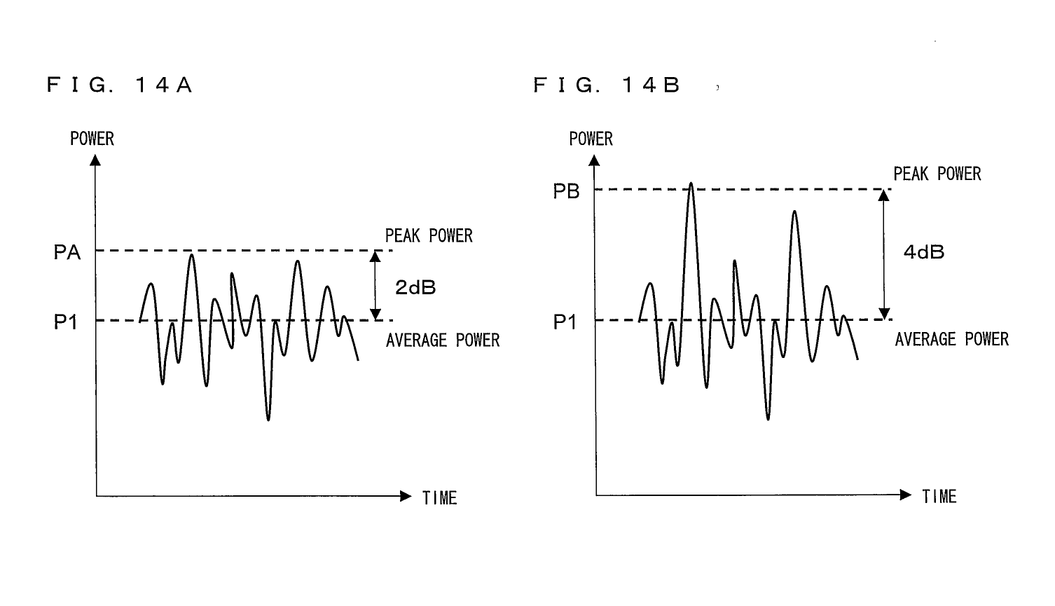

FIG. 14A and FIG. 14B are waveform charts of temporal variation of power of the amplified signal outputted from the amplifier circuit 10. In a case where the amplified signal outputted from the amplifier circuit 10 is a modulated signal modulated by, for example, CDMA (Code Division Multiple Access) or OFDM (Orthogonal Frequency Division Multiplexing), an amplitude of the amplified signal varies with elapse of time. In FIG. 14A, the peak power PA of the amplified signal is larger than the average power P1 by about 2 dB. In FIG. 14B, the peak power PB of the amplified signal is larger than the average power P1 by about 4 dB.

In a case where a modulated signal whose amplitude varies as described above is used, if a distortion rate of the amplified signal is decreased, occurrence of a signal which causes out-of-band jamming can be decreased. In order to achieve this, it is necessary to linearly amplify, in the amplifier circuit 10, a power of an inputted signal to the peak power. However, for example, if the amplifier circuit 10 is configured so as to be able to linearly amplify a power of an inputted signal to the peak voltage PB as shown in FIG. 14B and is operated at smaller power than the peak power PB, power efficiency of the amplifier circuit 10 decreases.

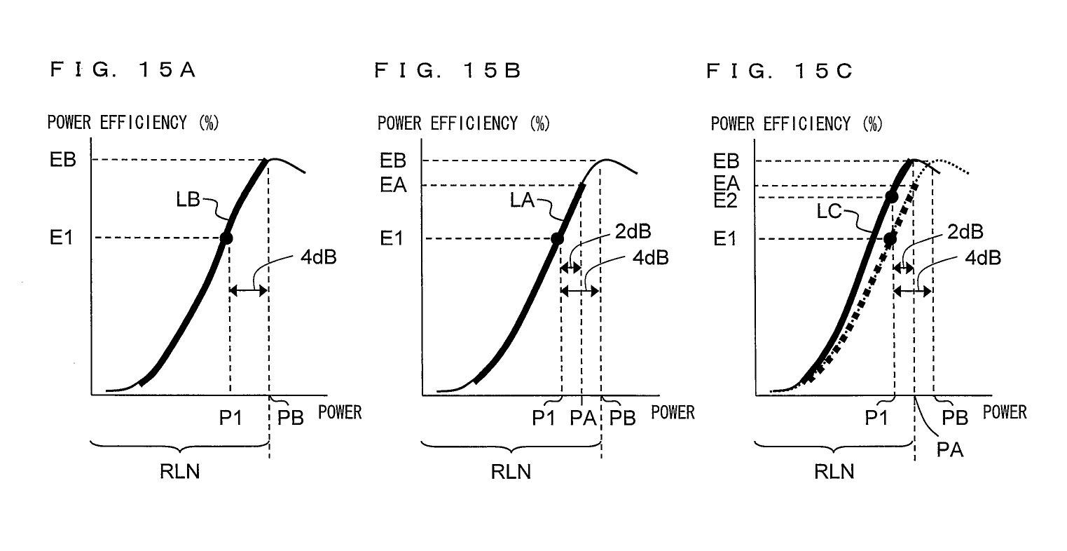

FIG. 15A and FIG. 15B are characteristic diagrams showing power efficiency obtained when the amplified signals shown in FIG. 14A and FIG. 14B are generated, respectively, by using the same amplifier circuit 10. An operating curve LB represented by the thick full line shown in FIG. 15A is characterized by the average power PI and the peak power PB that corresponds to the maximum limit power of a linear operation range RLN of the amplifier circuit 10. E1 is average power efficiency corresponding to the average power P1, and EB is peak power efficiency corresponding to the peak power PB. An operating curve LA represented by the thick full line shown in FIG. 15B is characterized by the average power P1 and the peak power PA that is smaller than the peak power PB. E1 is average power efficiency corresponding to the average power P1, and EA is peak power efficiency corresponding to the peak power PA and is smaller than EB. A case where the amplifier circuit 10 is in a state corresponding to the operating curve LB, is referred to as a high peak-power mode, and a case where the amplifier circuit 10 is in a state corresponding to the operating curve LA, is referred to as a low peak-power mode.

In the operating curve LA, since the peak power efficiency EA is smaller than EB as described above, the average power efficiency E1 is the same as in the operating curve LB even though the peak power PA of the amplified signal is lower than the peak power PB. Considering the above, the upper limit of the linear operation range RLN is decreased from the peak power PB so as to be equal to or lower than the peak power PA as shown by an operating curve LC represented by the thick full line in FIG. 15C, such that the peak power efficiency corresponding to the peak power PA is increased to EB, thereby causing the average power P1 to increase to E2 which is larger than E1 and enabling power efficiency of the amplifier circuit 10 to be improved.

Accordingly, in the specific example described above, the impedance conversion circuit 80-1 converts the load impedance Z1 into a load impedance which enables the upper limit of the linear operation range RLN to be decreased from the peak power PB so as to be equal to or lower than the peak power PA such that the peak power efficiency corresponding to the peak power PA is increased to EB, thereby enabling power efficiency of the amplifier circuit 10 to be improved.

As described above, according to the ninth embodiment, a load impedance is optimized for each peak power of the amplified signals by using the impedance conversion circuits 80-1 and 80-2. Therefore, even when the radio frequency circuit according to the ninth embodiment is used for a multimode mobile phone or the like which supports multiple kinds of modulation methods, it is possible to perform optimum impedance matching in accordance with each peak power of the amplified signals which are modulated by different modulation methods from each other, thereby enabling the amplifier circuit 10 to be optimized for each modulation method. Thus, according to the ninth embodiment, a radio frequency circuit suitable for multimode operation can be provided.

It is noted that, although the radio frequency circuit according to the ninth embodiment is obtained by altering the radio frequency circuit according to the first embodiment so as to enable multimode operation to be performed instead of multiband operation, the radio frequency circuit according to the ninth embodiment is not limited thereto. The radio frequency circuit according to any of the second to seventh embodiments may be altered so as to enable multimode operation to be performed instead of multiband operation.

### Tenth Embodiment

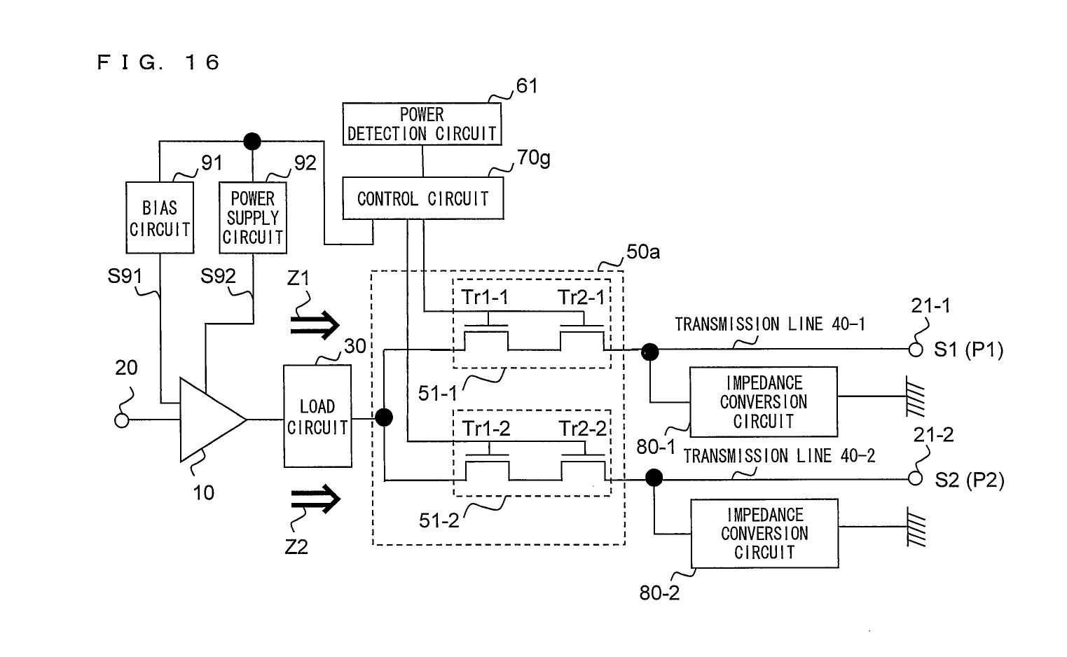

FIG. 16 is a block diagram showing an example of a configuration of a radio frequency circuit according to a tenth embodiment of the present invention. The radio frequency circuit according to the present embodiment is different from the radio frequency circuit shown in FIG. 12 according to the eighth embodiment, in that the radio frequency circuit according to the present embodiment includes a control circuit 70g in place of the control circuit 70e, and further includes a bias circuit 91 and a power supply circuit 92. Hereinafter, differences from the eighth embodiment will mainly be described. The rest of the configuration of the radio frequency circuit according to the tenth embodiment, and the operation and effect of the rest of the configuration, are the same as those of the eighth embodiment, and description thereof is omitted.

The control circuit 70g generates a control signal having selection information of a transmission line based on an average power detected by the power detection circuit 61, and outputs the control signal to the selection circuit 50a. Thus far, the control circuit 70g is operated similarly to the control circuit 70e according to the eighth embodiment. In addition to this, the control circuit 70g generates a control signal having an average power detected by the power detection circuit 61, and outputs the control signal to the bias circuit 91 and the power supply circuit 92.

The bias circuit 91 supplies, to the amplifier circuit 10, a bias output S91 which is dependent on the average power of the control signal outputted to the bias circuit 91 from the control circuit 70g. The bias output S91 is a bias current flowing into an input terminal of the amplifier circuit 10, or is an output having a voltage equal to a bias voltage between the input terminal and the common terminal. In addition, the bias output S91 is an output having, for example, a voltage proportional to the average voltage of the control signal outputted to the bias circuit 91 from the control circuit 70g.

The power supply circuit 92 supplies, to the amplifier circuit 10, a power supply voltage S92 which is dependent on the average voltage of the control signal outputted to the power supply circuit 92 from the control circuit 70g. The power supply voltage S92 has, for example, a voltage proportional to the average power of the control signal outputted to the power supply circuit 92 from the control circuit 70g.

As described above, according to the tenth embodiment, a load impedance is optimized for each average power of the amplified signals, and the bias output S91 and the power supply voltage S92 which are supplied to the amplified circuit 10 are also optimized in accordance with the average power. Thus, power efficiency of the amplifier circuit 10 is further improved and a distortion characteristic of the amplifier circuit 10 is further reduced.

It is noted that, although the control circuit 70g generates a control signal having an average power detected by the power detection circuit 61, the radio frequency circuit according to the tenth embodiment is not limited thereto. The radio frequency circuit according to the tenth embodiment may include the power detection circuit 61a in place of the power detection circuit 61 and cause the control circuit 70g to generate a control signal having a peak power detected by the power detection circuit 61a. In this case, the bias output S91 and the power supply voltage S92 which are supplied to the amplified circuit 10 are dependent on the peak voltage.

### Eleventh Embodiment

A radio frequency circuit suitable for multiband operation is described in the first embodiment, and a radio frequency circuit suitable for multimode operation is described in the eighth embodiment. However, a radio frequency circuit may be configured so as to be suitable for both multiband operation and multimode operation by combining the configurations according to the first and the eighth embodiments. In the present embodiment, an example of a radio frequency circuit suitable for both multiband operation and multimode operation will be described.

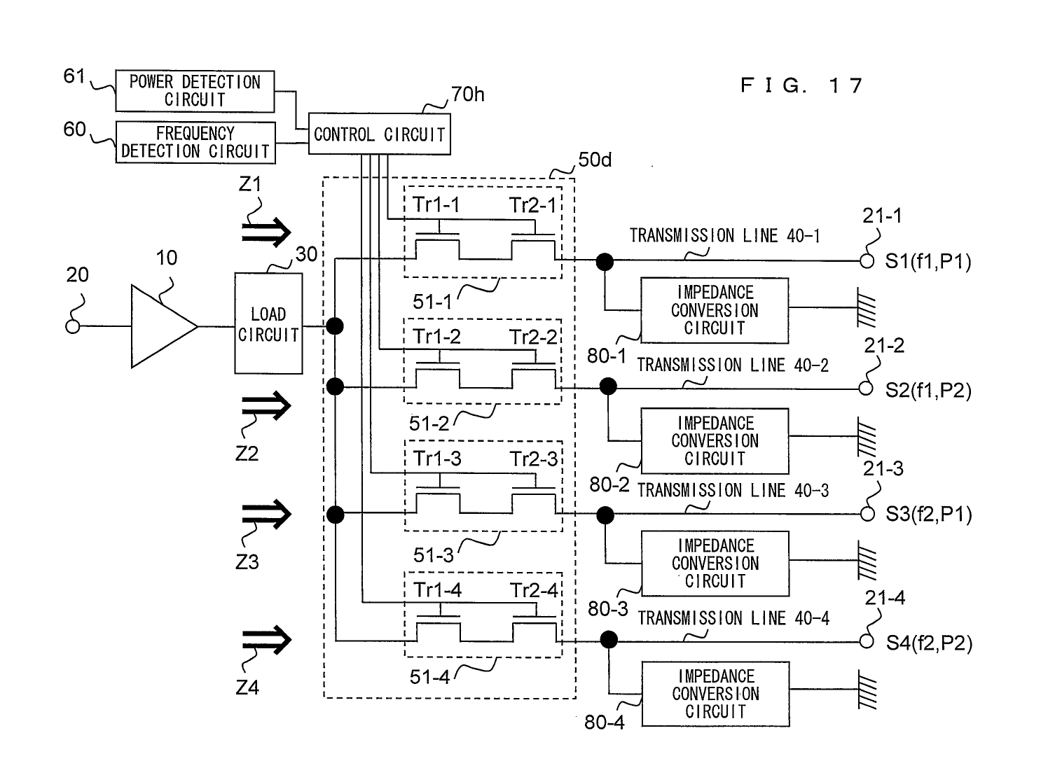

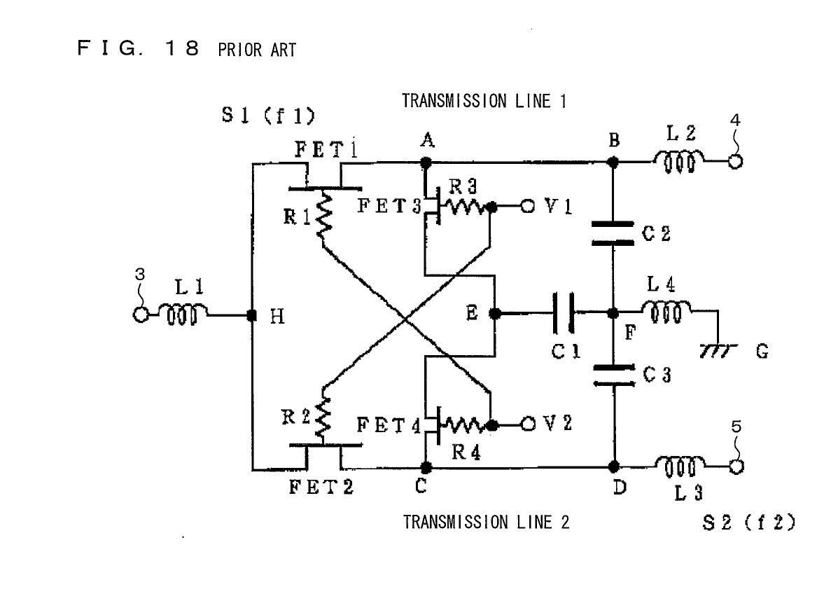

FIG. 17 is a block diagram showing an example of a configuration of a radio frequency circuit according to a eleventh embodiment of the present invention. The radio frequency circuit according to the present embodiment is different from the radio frequency circuit shown in FIG. 1 according to the first embodiment, in that the radio frequency circuit according to the present embodiment includes a selection circuit 50d in place of the selection circuit 50a and a control circuit 70h in place of the control circuit 70a, and further includes the power detection circuit 61, the transmission lines 40-3 and 40-4, the output terminals 21-3 and 21-4, and the impedance conversion circuits 80-3 and 80-4, and in that a transmission line is selected in accordance with a combination of a frequency and an average power of the amplified signal. Hereinafter, differences from the first embodiment will mainly be described. The rest of the configuration of the radio frequency circuit according to the eleventh embodiment, and the operation and effect of the rest of the configuration, are the same as those of the first embodiment, and description thereof is omitted.

In the example shown in FIG. 17, two kinds of frequencies (frequencies f1 and f2) and two kinds of average powers (average powers P1 and P2) are used for radio frequency signals. A radio frequency signal S1 has the frequency f1 and the average power P1, a radio frequency signal S2 has the frequency f1 and the average power P2, a radio frequency signal S3 has the frequency f2 and the average power P1, and a radio frequency signal S4 has the frequency f2 and the average power P2. In general, the frequency f1 and the frequency f2 are different from each other and satisfies, for example, the relationship f1<f2, and the average power P1 and the average power P2 are different from each other and satisfies, for example, the relationship P1<P2. In addition, in the example shown in FIG. 17, the selection circuit 50d selects a transmission line in accordance with a combination of a frequency and an average power of the radio frequency signal. The radio frequency signal S1 passes through the transmission line 40-1, the radio frequency signal S2 passes through the transmission line 40-2, the radio frequency signal S3 passes through the transmission line 40-3, and the radio frequency signal S4 passes through the transmission line 40-4. Z3 represents a load impedance looking from the amplifier circuit 10 toward the output side of the amplifier circuit 10 when the transmission line 40-3 is selected. Z4 represents a load impedance looking from the amplifier circuit 10 toward the output side of the amplifier circuit 10 when the transmission line 40-4 is selected.

The frequency detection circuit 60 detects a frequency of an amplified signal outputted from the amplifier circuit 10. In the present embodiment, there is described an example where the frequency detection circuit 60 detects the frequency f1 when an amplified signal based on the radio frequency signal S1 or S2 is outputted, and detects the frequency f2 when an amplified signal based on the radio frequency signal S3 or S4 is outputted.

The power detection circuit 61 detects an average power of an amplified signal outputted from the amplifier circuit 10. In the present embodiment, there is described an example where the power detection circuit 61 detects the average power P1 when an amplified signal based on the radio frequency signal S1 or S3 is outputted, and detects the average power P2 when an amplified signal based on the radio frequency signal S2 or S4 is outputted.

The control circuit 70h generates a control signal having selection information of a transmission line based on a frequency detected by the frequency detection circuit 60 and an average power detected by the power detection circuit 61, and outputs the control signal to the selection circuit 50d. Specifically, when the frequency f1 is detected by the frequency detection circuit 60 and the average power P1 is detected by the power detection circuit 61, the control circuit 70h outputs an ON signal to the transistor circuit 51-1 and outputs an OFF signal to the transistor circuits 51-2 to 51-4. Thus, the switching transistors Tr1-1 and Tr2-1 on the first path are turned ON, the switching transistors on the second to fourth paths are turned OFF. In this case, a signal amplified in the amplifier circuit 10 based on the radio frequency signal S1 passes through the load circuit 30 and then through the first path (the switching transistors Tr1-1 and Tr2-1, and the transmission line 40-1), and is outputted from the output terminal 21-1. Similarly, when the frequency f1 is detected by the frequency detection circuit 60 and the average power P2 is detected by the power detection circuit 61, the control circuit 70h causes a signal amplified in the amplifier circuit 10 based on the radio frequency signal S2 to pass through the load circuit 30 and then through the second path (the switching transistors Tr1-2 and Tr2-2, and the transmission line 40-2), and is outputted from the output terminal 21-2. When the frequency f2 is detected by the frequency detection circuit 60 and the average power P1 is detected by the power detection circuit 61, the control circuit 70h causes a signal amplified in the amplifier circuit 10 based on the radio frequency signal S3 to pass through the load circuit 30 and then through the third path (the switching transistors Tr1-3 and Tr2-3, and the transmission line 40-3), and is outputted from the output terminal 21-3. When the frequency f2 is detected by the frequency detection circuit 60 and the average power P2 is detected by the power detection circuit 61, the control circuit 70h causes a signal amplified in the amplifier circuit 10 based on the radio frequency signal S4 to pass through the load circuit 30 and then through the fourth path (the switching transistors Tr1-4 and Tr2-4, and the transmission line 40-4), and is outputted from the output terminal 21-4.

The impedance conversion circuit 80-1 converts the load impedance Z1 into a load impedance which enables maximum efficiency and maximum output power to be obtained from the amplifier circuit 10 at the frequency f1 and the average power P1. Similarly, the impedance conversion circuit 80-2 converts the load impedance Z2 into a load impedance which enables maximum efficiency and maximum output power to be obtained from the amplifier circuit 10 at the frequency f1 and the average power P2. The impedance conversion circuit 80-3 converts the load impedance Z3 into a load impedance which enables maximum efficiency and maximum output power to be obtained from the amplifier circuit 10 at the frequency f2 and the average power P1. The impedance conversion circuit 80-4 converts the load impedance Z4 into a load impedance which enables maximum efficiency and maximum output power to be obtained from the amplifier circuit 10 at the frequency f2 and the average power P2.

As described above, according to the eleventh embodiment, a load impedance is optimized for each combination of the frequencies and average powers of the amplified signals by using the impedance conversion circuits 80-1 to 80-4. Therefore, even when the radio frequency circuit according to the eleventh embodiment is used for a multiband and multimode mobile phone or the like which is operated in different radio frequency bands and in multiple kinds of communication modes, it is possible to perform optimum impedance matching in accordance with both various frequency bands to be used and each average power of the amplified signals which are used in different communication modes from each other, thereby enabling the amplifier circuit 10 to be optimized for each combination of the frequencies and average powers of the amplified signals. Thus, according to the eleventh embodiment, a radio frequency circuit suitable for both multiband operation and multimode operation can be provided.

It is noted that, although the radio frequency circuit according to the eleventh embodiment is obtained by altering the radio frequency circuit according to the first embodiment so as to enable multimode operation to be performed in addition to multiband operation, the radio frequency circuit according to the eleventh embodiment is not limited thereto. The radio frequency circuit according to any of the second to seventh embodiments may be altered so as to enable multimode operation to be performed in addition to multiband operation.

Moreover, in the radio frequency circuit according to the eleventh embodiment, although the selection circuit 50d selects a transmission path in accordance with a combination of a frequency and an average power of an amplified signal, the radio frequency circuit according to the eleventh embodiment is not limited thereto. The radio frequency circuit according to the eleventh embodiment may include the power detection circuit 61a in place of the power detection circuit 61 which detects a peak power of an amplified signal, and cause the selection circuit 50d to select a transmission path in accordance with a combination of a frequency and a peak power of an amplified signal.

### Twelfth Embodiment

In a twelfth embodiment, circuits formed by using a semiconductor chip will be described under the condition that the radio frequency circuits according to the first to eleventh embodiments are configured as semiconductor devices. Hereinafter, an example where the radio frequency circuit according to the fourth embodiment is configured as a semiconductor device will be described.

In the fourth embodiment described with reference to FIG. 8, at least one of the selection circuit 50b and the impedance conversion circuits 80-1 to 80-n is formed in one semiconductor chip. Each switch transistor (e.g., Tr1-1) included in the selection circuit 50b is formed by a FET (Field Effect Transistor). Particularly, when each of the switch transistors is formed by an HEMT (High Electron Mobility Transistor), the ON resistance per unit area of the chip is smaller than FET. Therefore, the signal loss occurring when the signal passes through the radio frequency circuit is reduced, and the area of the chip can be reduced. Moreover, if capacitance elements and inductor elements included in the impedance conversion circuits 80-1 to 80-n are formed on the semiconductor chip of the fourth embodiment, a radio frequency circuit having multiple functions and high performance can be formed in a further integrated semiconductor chip having a small area. Thus, there is obtained a significant effect in a case where a radio frequency circuit is desired to be miniaturized and have multiple functions. Moreover, it is desirable that the control circuit 70b is included in the semiconductor chip, so as to simplify the radio frequency circuit.

As described above, according to the twelfth embodiment, at least one of the selection circuit 50b and the impedance conversion circuits 80-1 to 80-n is formed in one semiconductor chip, thereby enabling the sizes and costs of the radio frequency circuit and the radio frequency power amplifier including the radio frequency circuit, to be decreased.

In the twelfth embodiment, the semiconductor chip, the amplifier circuit 10, and the load circuit 30 may be mounted on a substrate formed of a ceramic.

In all the embodiments described above, the switching transistors included in the selection circuits are formed by FETs. However, the switching transistors may be formed by other switches formed by using HEMTs, PIN diodes (Positive-Intrinsic-Negative Diodes), MEMS (Micro Electro Mechanical Systems), or the like. Each of the selection circuit and the transistor circuit may include one switching transistor, or may include a plurality of switching transistors.

In all the embodiment described above, an amplifying element included in the amplifier circuit 10 is formed by a bipolar transistor. However, the amplifying element may be formed by other transistors such as a heterojunction bipolar transistor, a silicon-germanium transistor, and an IGBT (Insulated Gate Bipolar Transistor). The amplifier circuit 10 may include one transistor of the above other transistors or may include a plurality of the above other transistors. The amplifier circuit 10 may include multiple stages. In a case where the amplifier circuit 10 includes the above other transistors, the emitter or the source thereof is grounded, in general. In this case, the input terminal is the base terminal or the gate terminal, the output terminal is the collector terminal or the drain terminal, and the common terminal is the emitter terminal or the source terminal.

The entire description of the embodiments is exemplary, and the present invention is not limited thereto and can be developed into various examples for those skilled in the art to easily configure by using the art of the present invention.

While the invention has been described in detail, the foregoing description is in all aspects illustrative and not restrictive. It is understood that numerous other modifications and variations can be devised without departing from the scope of the invention.

What is claimed is:

1. A radio frequency circuit for amplifying a radio frequency signal, the radio frequency circuit comprising:
an amplifier circuit for amplifying the radio frequency signal and outputting an amplified signal obtained by the amplification of the radio frequency signal;
a load circuit connected to an output of the amplifier circuit;
a plurality of transmission lines;
a selection circuit for selecting a transmission line among the plurality of transmission lines in accordance with a predetermined parameter of the amplified signal so as to connect the selected transmission line to an output of the load circuit; and
a conversion circuit for converting, into a predetermined load impedance, a load impedance looking from the amplifier circuit toward an output side of the amplifier circuit, the conversion being performed in the transmission line selected by the selection circuit.

2. The radio frequency circuit according to claim 1, wherein the conversion circuit includes a plurality of impedance conversion circuits: which are provided and connected to the plurality of transmission lines, respectively; and each of which converts the load impedance into the predetermined load impedance in accordance with the predetermined parameter of the amplified signal passing through the corresponding one of the plurality of transmission lines.

3. The radio frequency circuit according to claim 1, wherein:
the selection circuit includes a plurality of transistor circuits each of which: includes a plurality of switching transistors performing switching operation in accordance with the predetermined parameter of the amplified signal; and is provided between an output of the load circuit and the corresponding one of the plurality of transmission lines; and
the conversion circuit includes a plurality of impedance conversion circuits: which are provided to the plurality of transistor circuits, respectively; each of which is connected to a connection point existing among the plurality of switching transistors included in the corresponding one of the plurality of transistor circuits; and each of which converts the load impedance into the predetermined load impedance in accordance with the predetermined parameter of the amplified signal passing through the corresponding one of the plurality of transistor circuits.

4. The radio frequency circuit according to claim 1, wherein the conversion circuit includes a plurality of impedance conversion circuits: which are provided to the plurality of transmission lines, respectively; and each of which converts the load impedance into the predetermined load impedance in accordance with the predetermined parameter of the amplified signal passing through the corresponding one of the plurality of transmission lines, and
the radio frequency circuit further comprises a plurality of switching transistors which are provided to the plurality of impedance conversion circuits, respectively, and when the corresponding one of the transmission lines is selected by the selection circuit, connects the corresponding one of the impedance conversion circuits to the output of the load circuit by performing switching operation.

5. The radio frequency circuit according to claim 1, wherein:
the plurality of transmission lines are first and second transmission lines;
the selection circuit includes:
a first transistor circuit which is provided between the first transmission line and the output of the load circuit, and includes a plurality of first switching transistors which perform switching operation in accordance with the predetermined parameter of the amplified signal; and
a second transistor circuit which is provided between the second transmission line and the output of the load circuit, and includes a plurality of second switching transistors which perform switching operation in accordance with the predetermined parameter of the amplified signal;
the conversion circuit includes:
a first impedance conversion circuit which is connected to a connection point existing among the plurality of first switching transistors, and which converts the load impedance into the predetermined load impedance in accordance with the predetermined parameter of the amplified signal passing through the first transmission line; and
a second impedance conversion circuit which is provided to the second transistor circuit and which converts the load impedance into the predetermined load impedance in accordance with the predetermined parameter of the amplified signal passing through the second transmission line; and
the radio frequency circuit further comprises a third switching transistor which is provided between the second switching transistor circuit and the second impedance conversion circuit, and when the first transmission line is selected by the selection circuit, connects a connection point existing among the plurality of second switching transistors to the second impedance conversion circuit by performing switching operation.

6. The radio frequency circuit according to claim 1, wherein:
the plurality of transmission lines are first and second transmission lines;
the selection circuit includes:
a first transistor circuit which is provided between the first transmission line and the output of the load circuit, and includes a plurality of first switching transistors which perform switching operation in accordance with the predetermined parameter of the amplified signal; and
a second transistor circuit which is provided between the second transmission line and the output of the load circuit, and includes a plurality of second switching transistors which perform switching operation in accordance with the predetermined parameter of the amplified signal; and
the conversion circuit includes:
a passive circuit which is connected to a connection point existing among the plurality of second switching transistors, and converts the load impedance into the predetermined load impedance in accordance with the predetermined parameter of the amplified signal passing through the second transmittion line; and
a third switching transistor which is connected to a connection point existing among the plurality of second switching transistors, and when the first transmission line is selected by the selection circuit, causes the passive circuit to be bypassed by performing switching operation.

7. The radio frequency circuit according to claim 1, wherein the conversion circuit includes a capacitance.

8. The radio frequency circuit according to claim 1, wherein the conversion circuit includes an inductance.

9. The radio frequency circuit according to claim 1, wherein the predetermined parameter is a frequency of the amplified signal.

10. The radio frequency circuit according to claim 1, wherein the predetermined parameter is an average power of the amplified signal.

11. The radio frequency circuit according to claim 10, further comprising a bias circuit for supplying to the amplifier circuit a bias output having a bias current in accordance with the average power of the amplified signal or a bias voltage in accordance with the average power of the amplified signal.

12. The radio frequency circuit according to claim 10, further comprising a power supply circuit for supplying a power supply voltage in accordance with the average power of the amplified signal to the amplifier circuit.

13. The radio frequency circuit according to claim 1, wherein the predetermined parameter is a peak power of the amplified signal.

14. The radio frequency circuit according to claim 13, further comprising a bias circuit for supplying to the amplifier circuit a bias output having a bias current in accordance with the peak power of the amplified signal or a bias voltage in accordance with the average power of the amplified signal.

15. The radio frequency circuit according to claim 13, wherein further comprising a power supply circuit for supplying a power supply voltage in accordance with the peak power of the amplified signal to the amplifier circuit.

16. A semiconductor device comprising the radio frequency circuit according to claim 1, wherein at least one of the conversion circuit and the selection circuit is configured with use of a semiconductor chip.

17. A radio frequency power amplifier comprising the semiconductor device according to claim 16, wherein at least one of the amplifier circuit and the load circuit is formed on one substrate.
